(19) United States
(12) Patent Application Publication
(10) Pub. No.: US 2024/0406784 A1
(43) Pub. Date: Dec. 5, 2024

(54) METHOD FOR WIRELESS COMMUNICATION, AND TERMINAL DEVICE AND NETWORK DEVICE

(71) Applicant: GUANGDONG OPPO MOBILE TELECOMMUNICATIONS CORP., LTD., Dongguan (CN)

(72) Inventors: Zhe FU, Dongguan (CN); Yali GUO, Dongguan (CN)

(21) Appl. No.: 18/780,070

(22) Filed: Jul. 22, 2024

Related U.S. Application Data
(63) Continuation of application No. PCT/CN2022/074439, filed on Jan. 27, 2022.

(51) Int. Cl. H04W 28/02; H04W 72/543

(52) U.S. Cl. CPC H04W 28/0252; H04W 72/543

(57) ABSTRACT

Provided is a method for wireless communication. The method includes: performing, by a terminal device, a processing operation on data based on transmission requirement information of the data. The terminal device includes a processor and a memory storing one or more computer programs; wherein the processor, when loading and running the one or more computer programs in the memory, is caused to perform the method.

### CROSS-REFERENCE TO RELATED APPLICATION

This application is a continuation of International Application No. PCT/CN2022/074439, filed Jan. 27, 2022, the entire disclosure of which is incorporated herein by reference.

### TECHNICAL FIELD

Embodiments of the present disclosure relate to the field of communications, and in particular, relate to a method for wireless communication, and a terminal device and a network device thereof.

### BACKGROUND

In related arts, a network device allocates uplink transmission resources on a per-terminal-device basis, and the terminal device allocates resources to each logical channel (LCH) based on priorities of LCHs for data transmission over the LCH.

### SUMMARY

Embodiments of the present disclosure provide a method for wireless communication, and a terminal device and a network device thereof.

According to some embodiments of the present disclosure, a method for wireless communication is provided. The method includes: performing, by a terminal device, a processing operation on data based on transmission requirement information of the data.

According to some embodiments of the present disclosure, a terminal device is provided. The terminal device includes: a processor and a memory storing one or more computer programs; wherein the processor, when loading and running the one or more computer programs in the memory, is caused to perform the method as described above.

According to some embodiments of the present disclosure, a network device is provided. The network device includes: a processor and a memory storing one or more computer programs; wherein the processor, when loading and running the one or more computer programs in the memory, is caused to: transmit target configuration information to a terminal device, wherein the target configuration information is designed to configure LCH parameters for the terminal device to perform data processing and/or transmission.

### BRIEF DESCRIPTION OF DRAWINGS

FIG. 1 is a schematic diagram of an application scenario according to some embodiments of the present disclosure;

FIG. 2 is a schematic diagram of a method for wireless communication according to some embodiments of the present disclosure;

FIG. 3 is a schematic diagram of interaction of a method for wireless communication according to some embodiments of the present disclosure;

FIG. 4 is a schematic diagram of interaction of a method for wireless communication according to some embodiments of the present disclosure;

FIG. 5 is a schematic diagram of interaction of a method for wireless communication according to some embodiments of the present disclosure;

FIG. 6 is a schematic diagram of a method for wireless communication according to some embodiments of the present disclosure;

FIG. 7 is a schematic block diagram of a terminal device according to some embodiments of the present disclosure;

FIG. 8 is a schematic block diagram of a network device according to some embodiments of the present disclosure;

FIG. 9 is a schematic block diagram of a communication device according to some embodiments of the present disclosure;

FIG. 10 is a schematic block diagram of a chip according to some embodiments of the present disclosure; and

FIG. 11 is a schematic block diagram of a communication system according to some embodiments of the present disclosure.

### DETAILED DESCRIPTION

The technical solutions according to the embodiments of the present disclosure are described hereinafter in combination with the accompanying drawings in the embodiments of the present disclosure. It is obvious that the described embodiments are merely part but not all of the embodiments of the present disclosure. All other embodiments derived by those skilled in the art without creative efforts based on the embodiments in the present disclosure are within the protection scope of the disclosure.

The technical solutions according to the embodiments of the present disclosure are applicable to various communication systems, for example, a global system of mobile communication (GSM) system, a code division multiple access (CDMA) system, a wideband code division multiple access (WCDMA) system, a general packet radio service (GPRS) system, a long-term evolution (LTE) system, an advanced long-term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area networks (WLAN), a wireless fidelity (Wi-Fi), a 5^{th} generation (5G) system, other communication systems, or the like.

In general, traditional communication systems support a limited number of connections and are easy to implement. However, with the development of communication technologies, the mobile communication system supports traditional communications and other communications, for example, device-to-device (D2D) communications, machine-to-machine (M2M) communications, machine type communications (MTC), vehicle-to-vehicle (V2V) communications, vehicle-to-everything (V2X) communications, and the like. The embodiments of the present disclosure are applicable to the communication systems.

In some embodiments, the communication system in the embodiments of the present disclosure is applicable to a carrier aggregation (CA) scenario, a dual connectivity (DC) scenario, and a standalone (SA) networking scenario.

In some embodiments, the communication system in the embodiments of the present disclosure is applicable to an unlicensed spectrum, and the unlicensed spectrum is also construed as a shared spectrum. Alternatively, the communication system in the embodiments of the present disclosure is applicable to a licensed spectrum, and the licensed spectrum is also construed as a non-shared spectrum.

The embodiments of the present disclosure are described in conjunction with the network device and the terminal device. The terminal device is also referred to as a user equipment (UE), an access terminal, a subscriber unit, a subscriber station, a mobile station, a mobile, a remote station, a remote terminal, a mobile device, a user terminal, a terminal, a wireless communication device, a user proxy, a user device, or the like.

The terminal device is a station (ST) in WLAN, a cellular phone, a cordless phone, a Session Initiation Protocol (SIP) phone, a wireless local loop (WLL) ST, a personal digital assistant (PDA) device, a hand-held device with a wireless communication capability, a computing device or other processing devices connected to a wireless modem, an in-vehicle device, a wearable device, a next generation communication system, such as a terminal device in NR, a terminal device in an evolved public land mobile network (PLMN), or the like.

In the embodiments of the present disclosure, the terminal device is deployed on the land, for example, indoors or outdoors, handheld, wearable, or in vehicles; or deployed on water (for example, on a ship); or the terminal device is deployed in air (for example, on an airplane, a balloon, or a satellite).

In the embodiments of the present disclosure, the terminal device is a mobile phone, a pad, a computer with a radio transceiver function, a virtual reality (VR) device, an augmented reality (AR) device, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, or the like.

By way of example but not limitation, in the embodiments of the present disclosure, the terminal device may also be a wearable device. The wearable device is also referred to as a wearable smart device, and is a generic name of wearable devices such as glasses, gloves, watches, clothing, and shoes, which are intelligently designed and developed for daily wear by using wearable technologies. The wearable device is a portable device that is directly worn on the body or integrated into clothing or accessories of the user. The wearable device is not only a hardware device, but also implements powerful functions by software support, data interaction, and cloud interaction. The wearable smart device in a broad sense includes devices such as smart watches or smart glasses that have full functionality and large size, and are capable of implementing all or part of functionality without depending on the smart phone, and devices such as various kinds of smart bracelets and smart jewelries for monitoring physical signs, which are dedicated to a specific type of application functions and need to be used in cooperation with other devices such as the smart phone.

In the embodiments of the present disclosure, the network device is a device for communicating with the mobile device, the network device is an access point (AP) in WLAN, a base transceiver station (BTS) in GSM or CDMA, a NodeB (NB) in WCDMA, an evolved NodeB (eNB or eNodeB) in LTE, a relay station or an AP, an in-vehicle device, a wearable device, a network device in an NR network (gNB) or in an evolved PLMN or an NTN.

By way of example but not limitation, in the embodiments of the present disclosure, the terminal device is mobile. For example, the network device is a mobile device. In some embodiments, the network device is a satellite or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. In some embodiments, the network device is also an NB located on land, water, or the like.

In the embodiments of the present disclosure, the network device provides services for cells, and the terminal device communicates with the network device over the transmission resources (such as frequency domain resources, or spectrum resources) used in the cells. The cell is a cell corresponding to the network device (such as the NB), and the cell belongs to a macro NB or a NB corresponding to a small cell. The small cell includes a metro cell, a micro cell, a pico cell, a femto cell, or the like. The small cells have the small coverage and low transmission power, and are suitable for providing high rate data transmission services.

Illustratively, the communication system 100 in the embodiments of the present disclosure is shown in FIG. 1. The communication system 100 includes a network device 110, and the network device is a device communicated with a terminal device 120 (also referred to as a communication terminal or a terminal). The network device 110 provides communication coverage to a specific geographical area, and communicates with the terminal device in the coverage area.

FIG. 1 illustrates one network device and two terminal devices. In some embodiments, the communication system 100 includes a plurality of network devices, and each network devices covers other number of terminal devices, which is not limited in the embodiments of the present disclosure.

In some embodiments, the communication system 100 further includes a network controller, a mobile management entity, or other network entities, which is not limited in the embodiments of the present disclosure.

It should be noted that devices with the communication function in the network/system in the embodiments of the present disclosure are referred to as communication devices. By taking the communication system 100 shown in FIG. 1 as an example, the communication device includes the network device 110 and the terminal device 120 that have the communication function, and the network device 110 and the terminal device 120 are specific devices described above, which are not repeater herein. The communication device further includes other devices in the communication system 100, for example, the network controller, the mobile management entity, or other network entities, which is not limited in the embodiments of the present disclosure.

It should be understood that the terms “system” and “network” herein are interchangeably used. The term “and/or” herein describes an association relationship between associated objects, and indicates three types of relationships. For example, the phrase “A and/or B” means (A), (B), or (A and B). In addition, the symbol “/” generally indicates an “or” relationship between the associated objects.

It should be understood that the term “indicate” in the embodiments of the present disclosure means a direct indication, an indirect indication, or an indication that there is an associated relationship. For example, A indicating B means that A indicates B directly, e.g., B may be acquired by A; or that A indicates B indirectly, e.g., A indicates C by which B may be acquired; or that an association is present between A and B.

In the description of the embodiments of the present disclosure, the term “corresponding” mean that there is a direct correspondence or indirect correspondence between two objects, an association relationship between two objects, an indicating and being indicated relationship, or a configuring and being configured relationship.

In the embodiments of the present disclosure, the “predefinition” is achieved by pre-storing corresponding codes or forms in the device (for example, including the terminal device and the network device) or other means for indicating relevant information, and the specific implementations are not limited in the present disclosure. For example, the predefinition is defined in the protocol.

In the embodiments of the present disclosure, the “protocol” indicates standard protocols in the field of communications, for example, the LTE protocol, the NR protocol, and related protocols applied to the future communication system, which are not limited in the present disclosure.

In the NR system, the network device allocates the uplink resources based on the granularity of the terminal device (per-UE), and the terminal device determines data of which wireless bearer can be placed in the allocated uplink resources for transmission.

Based on the uplink resource configured by the network device, the terminal device requires to determine an amount of data transmitted over each LCH in a fronthaul medium access control protocol data unit (MAC PDU). In some cases, the terminal device further requires to allocate resources to a MAC control element (MAC CE). It is necessary to allocate a priority to each LCH to multiplex the LCH. For a MAC PDU with a determined size, in the case that a plurality of LCHs simultaneously have data transmission requirements, resources for transmission of the MAC PDU are allocated based on a descending order of priorities corresponding to uplink LCHs.

A prioritized bit rate (PBR) is introduced to balance fairness of various LCHs. In the case that the terminal device multiplexes the LCHs, a minimum data rate requirement of each LCH is first met to avoid a case that other LCHs with lower priorities of the terminal device are “starved” as the LCHs with higher priorities always occupy the uplink resources allocated by the network device to the terminal device.

To multiplex the LCHs, the network device configures the following parameters by radio resource control (RRC) signaling:
the priority of the LCH, the smaller a value of the priority, the higher the corresponding priority;
the PBR, indicating a minimum rate required by the LCH; and
a bucket size duration (BSD), determining a depth of a token bucket corresponding to the LCH.

A MAC layer of the terminal device multiplexes the LCHs using a token bucket mechanism.

Specifically, the terminal device maintains a variable Bj for each LCH j, and the variable indicates a number of current available tokens in the token bucket corresponding to the LCH. The number of tokens is set by the following methods:
(1) Bj is initialized to 0 when the terminal device establishes the LCH j;
(2) PBR*T is added to Bj prior to each logical channel prioritization (LCP) processing process by the terminal device, wherein T is an interval from a previous time of adding Bj to a current time; and
(3) Bj is set as a maximum volume of the token bucket in the case that Bj updated in step (2) is greater than a maximum volume of the token bucket (that is, PBR*BSD).

In the case that the terminal receives a newly transmitted uplink (UL) grant, the terminal performs the LCP processing by the following processes.

In S1, for all LCHs with Bj is greater than 0, resources are allocated based on a descending order of priorities, and the resource allocated to each LCH only meets a PBR requirement. That is, the resource is allocated to the LCH based on the number of tokens in a PBR token bucket corresponding to the LCH. In some embodiments, in the case that a PBR of an LCH is set to infinity, other LCHs with lower priorities than the LCH are considered only when the resource of the LCH is met.

In S2, a size of the LCH j multiplexed by all MAC service data units (SDUs) in the MAC PDU in S1 is subtracted from Bj.

In S3, in the case that there are remaining uplink resources upon S1 and S2, the remaining uplink resources are sequentially allocated to various LCHs based on the descending order of priorities of the LCHs no matter the size of Bj. Data of the LCHs with lower priorities is transmitted only when the data of the LCHs with higher priorities is transmitted and the UL grants are not exhausted. That is, the terminal device maximizes data transmission on the LCHs with higher priorities.

Meanwhile, the MAC layer of the terminal device follows the following principles in packetization:
1. a radio link control (RLC) SDU should not be segmented in the case that the RLC SDU can be padded in the remaining resources;
2. a maximum segment is padded as possible based on the size of the remaining resources in the case that the terminal device segments the RLC SDU in the LCH;
3. the terminal device should maximize transmission of the data; and
4. the UE should not only transmit a padding buffer status report (BSR) or only transmit the padding in the case that the UL grant size is greater than or equal to 8 bytes.

For different signals and/or LCHs, in performing the LCP processing, the terminal device should also follow the following priority order (a descending order of priorities):
a cell radio network temporary identity (C-RNTI) MAC CE or data from an uplink common control channel (UL-CCCH);
a configured grant confirmation MAC CE;
a BSR MAC CE used in addition to the padding BSR;
a single entry power headroom report (PHR) MAC CE or a multiple entry PHR MAC CE;
data from any LCH in addition to the UL-CCCH;
a MAC CE used for a recommended bit rate query; and
a BSR MAC CE used for the padding BSR.

With the development of the technologies, support of the communication system on the vertical industries is wider and deeper. Communication services include services in vertical industries, and such services may have different transmission requirements, for example, a quality of service (QOS) requirement and/or importance. Thus, how to process and transmit such services is an urgent problem to be solved. For example, an ultra-reliable and low delay communication (URLLC) requirement supports transmission of factory automation, transport industry, electrical power distribution, and other services in the NR system. An XR requirement supports transmission of AR, VR, cloud gaming, and other services. These services have requirements on the reliability and the delay. Thus, in the case that resources for these services are scheduled for the terminal device, the resources should meet the QoS requirement of the service transmission. A power consumption is also considered for the terminal device to avoid unnecessary power consumption. Meanwhile, for the network device, considering an access problem of a large number of terminal devices supporting the services, a requirement of a network capacity should be met in allocating resources.

As an example, the URLLC requirement or the XR requirement supports a service with requirements of at least 0.5 ms and the 99.999% reliability. The service is pseudo-periodic (that is, an arrival time of the service is jitter, that is, the service arrives not at a fixed time but at any time in a range). Meanwhile, the service period may be a non-integer period, for example, 16.67 ms. In addition, arrival times of different service streams of the same service may differ from each other greatly (for example, for the AR service, an UL pose period is 4 ms, but an UL video period is 16.67 ms).

For the AR service, the VR service, or the cloud gaming service, possible service models are as follows:
AR: UL pose information, a UL video stream, and a downlink (DL) video stream;
VR: UL pose information and a DL video stream; and
cloud gaming: UL control information and a DL video stream.

A period of the control information or the pose information is about 4 ms, a requirement of a packet size is about 100 bytes. A period of the video stream is about 16.67 ms, and a requirement of a packet size is about 0.67 Mbps.

In actual applications, different media units have different QoS requirements and/or importance. For example, for a video, the QoS requirement or the importance of an intra-coded picture frame (I frame) is greater than that of a predictive-coded picture frame (P frame). QoS requirements and/or importance of service streams or QoS streams of different media units are different.

Thus, for services with different QoS requirements and/or importance, how to appropriately process the services to improve a system capacity, avoid resource wasting, and ensure transmission of services with a high QoS requirement and/or high importance is an urgent problem to be solved.

For convenient understanding of the technical solutions according to the embodiments of the present disclosure, the technical solutions of the present disclosure are described in detail by detailed embodiments hereinafter. The following related technologies as optional solutions may be arbitrarily combined with the technical solutions according to the embodiments of the present disclosure, and fall within the scope of protection of the embodiments of the present disclosure. The embodiments of the present disclosure include at least some of the following contents, which is beneficial to meeting requirements of services with different QoS requirements and/or importance.

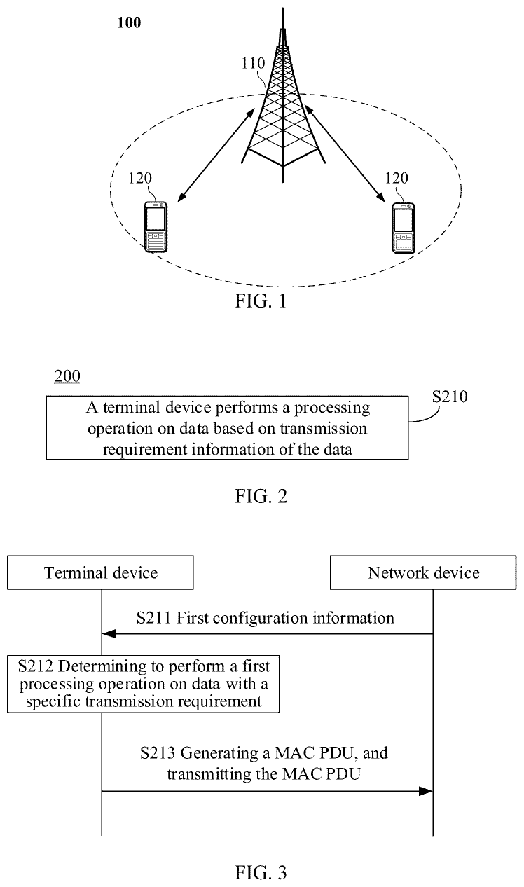

FIG. 2 is a schematic diagram of a method 200 for wireless communication according to some embodiments of the present disclosure. As shown in FIG. 2, the method 200 includes at least some of the following processes.

In S210, a terminal device performs a processing operation on data based on transmission requirement information of the data.

The terminal device processes the data based on the transmission requirement information of the data, such that transmission requirements of various data are met.

In some embodiments, the data includes to-be-processed data and/or to-be-transmitted data.

For example, the data includes data in a buffer of the terminal device and/or data submitted to a lower layer of the terminal device.

In some embodiments, the buffer of the terminal device includes a Packet Data Convergence Protocol (PDCP) buffer and/or a RLC buffer.

In some embodiments, the lower layer of the terminal device incudes a RLC layer and/or a MAC layer.

In some embodiments, the data includes a media unit or a data packet corresponding to a media unit. That is, the data includes the media unit, or the data includes partial data in the media unit.

In some embodiments, the media unit includes, but is not limited to, any of an application layer data packet, an application data unit (ADU), a frame, a coded slice, or the like of the terminal device. In some embodiments, the media unit may include a set of application layer data packets, ADUs, frames or coded slices; or the media unit may include a plurality of application layer data packets, a plurality of ADUs, a plurality of frames, or a plurality of coded slices.

In some embodiments, the data is a control packet or a data packet. The control packet is configured to carry control information, and the data packet is configured to carry data information.

In some embodiments, the data is an I frame or coded slice, a P frame or coded slice, or a bidirectionally predicted picture frame (B frame) or coded slice.

In some embodiments, the transmission requirement information of the data includes any parameter related to data transmission.

By way of example but not limitation, the transmission requirement information of the data includes at least one of: a QoS requirement of the data, importance of the data, a QoS requirement of a path of the data, or importance of a path of the data.

In some embodiments, the path of the data includes a QoS stream to which the data is mapped, a radio bearer to which the data is mapped, a PDCP layer to which the data is mapped, an RLC layer to which the data is mapped, a MAC layer to which the data is mapped, a carrier to which the data is mapped, or a hybrid automatic repeat request (HARQ) process to which the data is mapped.

In some embodiments, the importance of the data is defined based on a type of the data. For example, the control packet and the data packet correspond to different importance. The importance of the control packet is higher than the importance of the data packet. For example, the I frame or coded slice, the P frame or coded slice, and B frame or coded slice correspond to different importance. The importance of the I frame or coded slice is higher than the importance of the P frame or coded slice and the importance of the B frame or coded slice. Alternatively, the importance of the data is determined based on a priority instruction of the data. For example, data with a lower priority instruction value corresponds to higher importance, data with a higher priority instruction value corresponds to lower importance, or the like.

In some embodiments, the processing operation includes, but is not limited to resource scheduling and/or resource allocation, or QoS mapping or assurance.

In some embodiments, the processing operation includes, but is not limited to a processing operation of the MAC layer.

In some embodiments, the processing operation includes, but is not limited to at least one of: LCP processing, MAC PDU packetization, LCH mapping using an LCP mapping restriction, or resource selection (that is, resource allocation) using an LCP mapping restriction.

In some embodiments, the terminal device performs different processing operations on data with a specific transmission requirement and data with a non-specific transmission requirement.

In some embodiments, a QoS requirement and/or importance of the data with the specific transmission requirement is higher than a QoS requirement and/or importance of the data with the non-specific transmission requirement.

In some embodiments, the data with the specific transmission requirement includes at least one of: data with a high QoS requirement, data with high importance, data with a QoS requirement higher than a first QoS threshold, data with importance higher than a first importance threshold, or data carrying a specific identifier.

In some embodiments, the data with the non-specific transmission requirement includes at least one of: data with a low QoS requirement, data with low importance, data with a QoS requirement lower than the first QoS threshold, data with importance lower than the first importance threshold, or data not carrying a specific identifier.

In some embodiments, the data includes identifier information indicating the type of the data, such as the control packet or the data packet; the I frame, the P frame or the B frame; an important type or a non-important type; or indicating a value of the priority, or the like.

In some embodiments, the data carrying the specific identifier includes at least one of: data carrying a control packet identifier, data carrying an I frame identifier, a data packet carrying an importance type identifier, or a packet carrying a high priority identifier.

In some embodiments of the present disclosure, the terminal device determines the data with the specific transmission requirement as a high-prioritized data packet, or determines a HARQ process corresponding to the data with the specific transmission requirement as a prioritized HARQ process, or determines uplink grant corresponding to the data with the specific transmission requirement as a prioritized uplink grant, or determines downlink grant corresponding to the data with the specific transmission requirement as a prioritized downlink grant, or determines a carrier corresponding to the data with the specific transmission requirement as a prioritized carrier.

In some embodiments of the present disclosure, the terminal device determines the data with the non-specific transmission requirement as a low-prioritized data packet, or determines a HARQ process corresponding to the data with the non-specific transmission requirement as a low-prioritized HARQ process, or determines uplink grant corresponding to the data with the non-specific transmission requirement as a low-prioritized uplink grant, or determines downlink grant corresponding to the data with the non-specific transmission requirement as a low-prioritized downlink grant, or determines a carrier corresponding to the data with the non-specific transmission requirement as a low-prioritized carrier.

In some embodiments, the HARQ process corresponding to the data with the specific transmission requirement refers to a HARQ process used in transmitting the data with the specific transmission requirement, the uplink grant corresponding to the data with the specific transmission requirement refers to uplink grant used in transmitting the data with the specific transmission requirement, the downlink grant corresponding to the data with the specific transmission requirement refers to downlink grant used in transmitting the data with the specific transmission requirement, and the carrier corresponding to the data with the specific transmission requirement refers to a carrier used in transmitting the data with the specific transmission requirement.

In some embodiments, the MAC of the terminal device determines, based on a mapping relationship between any of a data radio bearer (DRB), an LCH, the HARQ process or the uplink grant and the data, whether the DRB, the LCH, the HARQ process, or the uplink grant corresponds to the data with the specific transmission requirement, or determines, based on identifier information of the data corresponding to the DRB, the LCH, the HARQ process, or the uplink grant, whether the DRB, the LCH, the HARQ process, or the uplink grant corresponds to the data with the specific transmission requirement. For example, in the case that a DRB corresponds to an identifier of prioritized data, the DRB corresponds to the data with the specific transmission requirement. In some embodiments, the identifier of the prioritized data includes, but is not limited to the control packet identifier, the I frame identifier, the importance type identifier, and the high priority identifier. For example, in the case that a DRB corresponds to the identifier of the prioritized data, and a HARQ process carries the DRB, the HARQ process is a process corresponding to the specific transmission requirement, and the HARQ process corresponds to the data with the specific transmission requirement.

That is, in that case that the data is transmitted over the resource, which DRB or the LCH for prioritized processing is determined based on whether the DRB or the LCH has a mapping relationship with high-prioritized data, or whether the DRB or the LCH is configured with the identifier of the prioritized data. For example, in that case that a first DRB or a first LCH has a mapping relationship with high-prioritized data, or a first DRB or a first LCH is configured with the identifier of the prioritized data, the first DRB or the first LCH is processed with priority. For example, in that case that a first DRB or a first LCH has a mapping relationship with high-prioritized data, or a first DRB or a first LCH is configured with the identifier of the prioritized data, the HARQ process or the grant of the first DRB or the first LCH is processed with priority. In some embodiments, which HARQ process or the uplink grant for prioritized processing, or data for prioritized transmission corresponding to which HARQ process or the uplink grant is determined based on whether the HARQ process or the uplink grant has a mapping relationship with high-prioritized data, or whether the HARQ process or the uplink grant is configured with the identifier of the prioritized data. For example, in the case that a first HARQ process or a first uplink grant has a mapping relationship with high-prioritized data, or a first HARQ process or a first uplink grant is configured with the identifier of the prioritized data, data corresponding to the first HARQ process or the first uplink grant is transmitted with priority. Detailed implementations of processing the data based on the transmission requirement information of the data by the terminal device are described hereinafter in conjunction detailed embodiments.

### First Embodiments

In some embodiments, the first embodiments are applicable to a scenario of mapping data with different transmission requirements (for example, the QoS requirement or importance) to different DRBs, LCHs, or PDCPs.

In some embodiments of the present disclosure, the method 200 further includes:
receiving, by a terminal device, first configuration information from a network device, wherein the first configuration information includes LCH parameters corresponding to the data.

It should be understood that the first configuration information is configured by any downlink signaling, for an example not a limitation, RRC signaling. In some embodiments, in the case that the first configuration information is configured by the RRC signaling, the first configuration information is also referred to as an RRC configuration parameter.

In some embodiments, the first configuration information includes first LCH parameters and second LCH parameters.

In some embodiments, the first LCH parameters are configured for the data with the specific transmission requirement, and the second LCH parameters are configured for the data with the non-specific transmission requirement. That is, compared with the second LCH parameters, processing or transmission of the data based on the first LCH parameters is beneficial to meeting the transmission requirement of the data with the specific transmission requirement. Thus, the network device configures a plurality of series of LCH parameters for facilitating differentiated processing or transmission of data with different transmission requirements by the terminal device.

In some embodiments, the specific transmission requirement is organized to a plurality of transmission requirement levels, and the network device configures a plurality of series of LCH parameters for the plurality of transmission requirement levels. In using the LCH parameters, the terminal device uses corresponding LCH parameters based on the transmission requirement levels of the data to process or transmit the data, and detailed configuring method and subsequent using method are similar, which are not described herein.

In some embodiments, the first configuration information includes the second LCH parameters. In some embodiments, the second LCH parameters are configured for the data with the non-specific transmission requirement. That is, processing or transmission of the data with the specific transmission requirement based on the second LCH parameters may not meet the transmission requirement of the data with the specific transmission requirement.

In some embodiments, the first LCH parameters or the second LCH parameters include at least one of: an LCP, a PBR, a BSD, or an LCH mapping restriction.

In some embodiments, the LCH mapping restriction includes, but is not limited to configured grant (CG) allowing LCH mapping, and/or dynamic grant (DG) allowing LCH mapping.

In some embodiments, the first LCH parameters include parameters corresponding to a first processing operation, or parameters used in a first processing operation.

In some embodiments, the terminal device performs the first processing operation on the data with the specific transmission requirement based on the parameters corresponding to the first processing operation, such that the data with the specific transmission requirement is transmitted or processed with priority.

In some embodiments, the first processing operation includes, but is not limited to at least one of: performing LCP processing on the data using a first LCP rule; packetizing the data using a first MAC packetization mode; or performing LCH mapping and/or resource selection on the data using a first LCH mapping restriction.

That is, the parameters corresponding to the first processing operation include parameters corresponding to the first LCP rule, and/or parameters corresponding to the first MAC packetization mode, and/or parameters corresponding to the first LCH mapping restriction.

In some embodiments, the transmission requirement of the data is met by processing the data with the specific transmission requirement using the first LCP rule, using the first MAC packetization mode, or using the first LCH mapping restriction.

In some embodiments, the first embodiments are applicable to a scenario of mapping data with different transmission requirements (for example, the QoS requirement or importance) to different DRBs, LCHs, or PDCPs.

In some embodiments, the parameters corresponding to the first processing operation include at least one of: an LCP, a PBR, a BSD, or a first LCH mapping restriction.

In some embodiments, the parameters corresponding to the first processing operation are determined by the terminal device.

In this case, the first configuration information does not include the parameters corresponding to the first processing operation, or does not include the first LCH parameters.

In some embodiments, the second LCH parameters include parameters corresponding to a second processing operation, or parameters used in a second processing operation.

In some embodiments, the terminal device performs the second processing operation on the data with the non-specific transmission requirement based on the parameters corresponding to the second processing operation.

In some embodiments, the second processing operation includes, but is not limited to at least one of: performing LCP processing on the data using a second LCP rule; packetizing the data using a second MAC packetization mode; or performing LCH mapping and/or resource selection on the data using a second LCH mapping restriction.

That is, the parameters corresponding to the second processing operation include parameters corresponding to the second LCP rule, and/or parameters corresponding to the second MAC packetization mode, and/or parameters corresponding to the second LCH mapping restriction.

In some embodiments, the transmission requirement of the data is met by processing the data with the non-specific transmission requirement using the second LCP rule, using the second MAC packetization mode, or using the second LCH mapping restriction.

In some embodiments, the parameters corresponding to the second processing operation include at least one of: a priority, a PBR, a BSD, or a second LCH mapping restriction.

In some embodiments, the first configuration information further includes a first correspondence indicating a correspondence between at least one of a DRB, an LCH, or a PDCP layer and the transmission requirement information of the data.

For example, the first correspondence is a correspondence of the DRB and the QoS requirement or the importance, a correspondence of the LCH and the QoS requirement or the importance, or a correspondence of the PDCP layer and the QoS requirement or the importance.

Thus, the terminal device maps the data with different QoS requirements or importance to different DRBs, LCHs, or PDCP layers based on the first correspondence, such that the data with different QoS requirements or importance is processed appropriately, and the transmission of the data with the high QoS requirement or high importance is ensured.

In some embodiments, the first configuration information further includes first parameter information indicating transmission requirement parameters of data associated with at least one of the DRB, the LCH, or the PDCP layer.

For example, the first parameter information includes a QoS requirement parameter or an importance parameter associated with the DRB, and/or a QoS requirement parameter or an importance parameter associated with the LCH, and/or a QoS requirement parameter or an importance parameter associated with the PDCP layer.

Thus, the terminal determines the QoS requirement or the importance that can be met by the DRB, the LCH, or the PDCP layer based on the first parameter information, and further maps the data with different QoS requirements or importance to different DRBs, LCHs, or PDCP layers, such that the data with different QoS requirements or importance is processed appropriately, and the data with the high QoS requirement or high importance is transmitted.

That is, the terminal device configures the QoS requirement or importance corresponding to the DRB, the LCH, or the PDCP layer, or configures QoS requirement related parameters or importance related parameters corresponding to the DRB, the LCH, or the PDCP layer, such that the terminal device determines the QoS requirement or the importance that can be met by the DRB, the LCH, or the PDCP layer based on the QoS requirement related parameters or the importance related parameters, and further performs appropriate mapping on the data based on the QoS requirement or the importance of the data.

In some embodiments, the first configuration information further includes first indication information indicating whether to activate the first LCH parameters, or whether to enable the first processing operation. For example, the first indication information indicates whether to enable the first LCP rule, whether to enable the first MAC packetization mode, or whether to enable the first LCH mapping restriction.

In some embodiments, in the case that the first indication information instructs to activate the first LCH parameters or to enable the first processing operation, the terminal device processes the data with the specific transmission requirement based on the first LCH parameters, or performs the first processing operation on the data with the specific transmission requirement.

In some embodiments, in the case that the first indication information instructs to deactivate the first LCH parameters or to disable the first processing operation, the terminal device processes the data with the specific transmission requirement based on the second LCH parameters, or performs the second processing operation on the data with the specific transmission requirement.

In some embodiments, the first indication information and the above LCH parameters are configured by a same signaling, or by different signaling. For example, the first indication information is transmitted by the downlink control information (DCI) or the MAC CE.

In some embodiments, the first LCH parameter, the first processing operation, the second LCH parameter, or the second processing operation is used based on a duration. The duration corresponding to a timer.

In some embodiments, the first configuration information further includes a first duration indicating a using or enabling duration of the first LCH parameters or the first processing operation. For example, the first LCH parameter or the first processing operation is used within the first duration, and the first LCH parameter or the first processing operation is not used or the second LCH parameter or the second processing operation is used upon run-out of the first duration.

In some embodiments, the first duration is configured by the network device, for example, configured by the first configuration information, configured by single signaling, predefined, that is, without indication of the network device, or determined by the terminal device.

In some embodiments, the first configuration information further includes a second duration indicating a using or enabling duration of the second LCH parameters or the second processing operation. For example, the second LCH parameter or the second processing operation is used within the second duration, and the second LCH parameter or the second processing operation is not used or the first LCH parameter or the first processing operation is used upon run-out of the second duration.

In some embodiments, the second duration is configured by the network device, for example, configured by the first configuration information, configured by single signaling, predefined, that is, without indication of the network device, or determined by the terminal device.

In some embodiments, the first configuration information further includes a third duration indicating a disabling or non-use duration of the first LCH parameters or the first processing operation. For example, the first LCH parameter or the first processing operation is not used within the third duration, and the first LCH parameter or the first processing operation is used or the second LCH parameter or the second processing operation is not used upon run-out of the third duration.

In some embodiments, the third duration is configured by the network device, for example, configured by the first configuration information, configured by single signaling, predefined, that is, without indication of the network device, or determined by the terminal device.

In some embodiments, the first configuration information further includes a fourth duration indicating an non-use or disabling duration of the second LCH parameters or the second processing operation. For example, the second LCH parameter or the second processing operation is not used within the fourth duration, and the second LCH parameter or the second processing operation is used or the first LCH parameter or the first processing operation is not used upon run-out of the fourth duration.

In some embodiments, the fourth duration is configured by the network device, for example, configured by the first configuration information, configured by single signaling, predefined, that is, without indication of the network device, or determined by the terminal device.

In some embodiments, the first duration is equal to the fourth duration.

In some embodiments, the second duration is equal to the third duration.

In some embodiments, the data is acquired by a first layer of the terminal device from a higher layer of the terminal device, and the higher layer of the terminal device is above the first layer.

In some embodiments, the first layer of the terminal device includes, but is not limited to at least one of: a Service Data Adaptation Protocol (SDAP) layer, a PDCP layer, or a MAC layer.

In some embodiments, the first layer of the terminal device determines whether the data is the data with the specific transmission requirement upon acquiring the data.

In some embodiments, the first layer of the terminal device determines whether the data is the data with the specific transmission requirement based on indication of the higher layer of the terminal device, or self-determines whether the data is the data with the specific transmission requirement.

In some embodiments, the first layer of the terminal device determines to perform the first processing operation in the case that the data is the data with the specific transmission requirement. In some embodiments, the first layer of the terminal device transmits second indication information to the MAC layer of the terminal device. The second indication information indicates that the data is the data with the specific transmission requirement, or the second indication information is designed to instruct to perform the first processing operation.

In some embodiments, the first layer of the terminal device further determines to perform the second processing operation in the case that the data is the data with the non-specific transmission requirement. In some embodiments, the first layer of the terminal device transmits third indication information to the MAC layer of the terminal device. The third indication information indicates that the data is the data with the non-specific transmission requirement, or the third indication information is designed to instruct to perform the second processing operation.

In some embodiments, in the case that the data is the data with the specific transmission requirement, the terminal device transmits indication information to the network device to indicate that the data with the specific transmission requirement is present or instruct the network device to adjust the first configuration information. Furthermore, the network device determines that the data with the specific transmission requirement is present based on the indication information or determines to adjust the LCH parameters to ensure the transmission requirement of the data with the specific transmission requirement. For example, in the case that the network device does not configure the first LCH parameters for the terminal device, the network device configures the first LCH parameters for the terminal device in the case that the network device receives the indication information from the terminal device. Alternatively, in the case that the network device has configured the first LCH parameters for the terminal device, the network device instructs to activate the first LCH parameters based on the first indication information.

In some embodiments, the first processing operation is activated by default, self-activated by the terminal device, activated based on a condition (that is, the terminal device performs the first processing operation on the data in a specific condition), activated periodically, or activated in response to the first LCH parameters being configured.

In some embodiments, the terminal device performs the first processing operation on the data in response to a first condition being met.

For example, in the case that the first condition is met, the MAC layer of the terminal device performs the first processing operation on the data.

In some embodiments, the first condition includes, but is not limited to at least one of:
the MAC layer of the terminal device receives the second indication information from the first layer of the terminal device;
a buffer of the terminal device contains data with a specific transmission requirement; transmission of the data with the specific transmission requirement is not completed;
a quantity of available resources is less than an amount of the data with the specific transmission requirement;
LCH parameters corresponding to the data with the specific transmission requirement are not matched with the amount of the data with the specific transmission requirement;
currently used LCH parameters are not matched with the amount of the data with the specific transmission requirement;
a transmission delay of the data with the specific transmission requirement is greater than a first delay threshold;
a transmission delay of data with a non-specific transmission requirement is greater than a second delay threshold;
a duration of disabling the first processing operation reaches a third duration; or
a duration of enabling a second processing operation reaches a second duration.

In some embodiments, in the case that the first condition is met, the terminal device performs the LCP processing or the MAC PDU packetization using the first LCP rule, using the first MAC packetization mode, or using the first LCH mapping restriction, and further transmit the data.

In some embodiments, that the buffer of the terminal device contains the data with the specific transmission requirement includes at least one of: the data with the specific transmission requirement is not transmitted, or the data with the specific transmission requirement is not processed.

In some embodiments, that the data with the specific transmission requirement is not processed includes at least one of: the LCP processing is not performed on the data with the specific transmission requirement, the MAC PDU packetization is not performed on the data with the specific transmission requirement, the LCH mapping is not performed on the data with the specific transmission requirement, or the resource allocation is not performed on the data with the specific transmission requirement.

In some embodiments, that the transmission of the data with the specific transmission requirement is not completed includes at least one of: the buffer of the terminal device contains the data with the specific transmission requirement, or the data with the specific transmission requirement that is not transmitted is present in the lower layer of the terminal device, or the data with the specific transmission requirement that is transmitted improperly is present in the terminal device, or the data with the specific transmission requirement for which a positive acknowledgement (ACK) is not received is present in the terminal device.

In some embodiments, in the case that the size of the available resource is less than the amount of the data with the specific transmission requirement, the LCP processing or the MAC PDU packetization is performed on the data based on the first processing operation, such that the resource is allocated with priority to the data with the specific transmission requirement, and the transmission of the data with the specific transmission requirement is ensured.

In some embodiments, that the LCH parameters corresponding to the data with the specific transmission requirement are not matched with the amount of the data with the specific transmission requirement includes at least one of: the first configuration information only includes the second LCH parameters, but a token bucket size of the LCH configured based on the second LCH parameters is less than the amount of the data with the specific transmission requirement; or the first configuration information includes the first LCH parameters, but a token bucket size of the LCH configured based on the first LCH parameters is less than the amount of the data with the specific transmission requirement. In some embodiments, the currently used LCH parameters refer to the second LCH parameters in the case that the first configuration information only includes the second LCH parameters, or refer to the first LCH parameters or the second LCH parameters in the case that the first configuration information includes the first LCH parameters and the second LCH parameters.

In some embodiments, that the currently used LCH parameters are not matched with the amount of the data with the specific transmission requirement includes: a token bucket size of the LCH configured based on the currently used LCH parameters is less than the amount of the data with the specific transmission requirement.

In some embodiments, the transmission delay of the data with the specific transmission requirement being greater than the first delay threshold means that a remaining transmission time of the data with the specific transmission requirement is less, and thus the data with the specific transmission requirement is transmitted with priority to meet a delay requirement of the data.

In some embodiments, the transmission delay of the data refers to a duration from a start time of the data transmission to a time at which the data is transmitted to the opposite end or is successfully received by the opposite end (for example, the ACK from the opposite end is received).

In some embodiments, the start time of the data refers to a time at which the data arrives or is stored in the buffer of the terminal device, a time at which the data is generated, a time at which the data arrives at an air interface, a time at which the data arrives at the PDCP layer, or a start time at which the data is transmitted in the lower layer of the terminal device.

For example, the transmission delay of the data is a duration from generation of the data to reception of the data by the opposite end, or a duration from arrival of the data to the PDCP layer to successful reception of the data by the opposite end. For example, a duration in which the data is transmitted by the lower layer of the terminal device but feedback information from the opposite end is not received is construed as the transmission delay of the data, a duration consumed by transmission, or a part of the transmission delay.

In some embodiments, the first delay threshold is predefined, configured by the network device, for example, configured in the first configuration information, or determined by the terminal device.

In some embodiments, the first delay threshold is a packet delay budget (PDB).

In some embodiments, the transmission delay of the data with the non-specific transmission requirement being greater than the second delay threshold means that a remaining transmission time of the data with the non-specific transmission requirement is less. That is, the delay requirement is not met even if the data with the non-specific transmission requirement is transmitted immediately. Thus, the data with the specific transmission requirement is transmitted with priority to meet the delay requirement of the data with the specific transmission requirement.

In some embodiments, the second delay threshold is predefined, configured by the network device, for example, configured in the first configuration information, or determined by the terminal device.

In some embodiments, the second delay threshold is a PDB.

In some embodiments, the terminal device enables or disables the first processing operation periodically, or enables or disables the first LCH parameters periodically.

For example, for periodically disabling the first processing operation, a timer is periodically started, and a duration of the timer is a third duration. The first processing operation is disabled during running of the timer, and the first processing operation is enabled in response to expiration of the timer. Furthermore, the second processing operation is disabled in response to enabling of the first processing operation.

In some embodiments, periodically enabling or disabling the first processing operation based on the timer is applicable to periodically transmitted data.

In some embodiments, the terminal device enables or disables the second processing operation periodically, or enables or disables the second LCH parameters periodically.

For example, for periodically enabling the second processing operation, a timer is periodically started, and a duration of the timer is a second duration. The second processing operation is disabled upon expiration of the timer. Furthermore, the first processing operation is enabled in response to the second processing operation being disabled.

In some embodiments, performing, by the terminal device, the first processing operation on the data in response to the first condition being met includes:
modifying a second LCH mapping restriction, and performing the LCH mapping and/or the resource selection on the data using the modified second LCH mapping restriction, wherein the second LCH mapping restriction is configured for the data with the non-specific transmission requirement; or
performing the LCH mapping and/or the resource selection on the data using the first LCH mapping restriction, wherein the first LCH mapping restriction is configured for the data with the specific transmission requirement.

For example, in the case that the first configuration information only includes parameters corresponding to the second LCH mapping restriction, and the first condition is met, the terminal device modifies the second LCH mapping restriction, and performs the LCH mapping and/or the resource selection on the data with the specific transmission requirement based on the modified second LCH mapping restriction.

For example, in the case that the first configuration information includes parameters corresponding to the first LCH mapping restriction, and the first condition is met, the terminal device performs the LCH mapping and/or the resource selection on the data with the specific transmission requirement based on the first LCH mapping restriction.

In some embodiments, the modified second LCH mapping restriction includes that only the LCH corresponding to the data with the specific transmission requirement is allowed to be mapped onto the first resource in the case that a plurality of LCHs are to be mapped onto the first resource, and a first LCH in the plurality of LCHs is the LCH corresponding to the data with the specific transmission requirement.

Thus, in the case that the resource selection is performed based on the modified second LCH mapping restriction, the resource is allocated with priority to the data with the specific transmission requirement, and thus the data with the specific transmission requirement is transmitted with priority.

In some embodiments, the first LCH mapping restriction includes that only the LCH corresponding to the data with the specific transmission requirement is allowed to be mapped onto the first resource in the case that a plurality of LCHs are to be mapped onto the first resource, and a first LCH in the plurality of LCHs is the LCH corresponding to the data with the specific transmission requirement.

Thus, in the case that the resource selection is performed based on the first LCH mapping restriction, the resource is allocated with priority to the data with the specific transmission requirement, and thus the data with the specific transmission requirement is transmitted with priority.

In some embodiments, performing the first processing operation on the data in response to the first condition being met includes:
modifying a second LCP rule, and performing the LCP processing on the data using the modified second LCP rule, such that an uplink grant resource includes the data, wherein the second LCP rule is configured for data with a non-specific transmission requirement; or
performing the LCP processing on the data using the first LCP rule, such that an uplink grant resource includes the data, wherein the first LCP rule is configured for data with a specific transmission requirement.

For example, in the case that the first configuration information only includes parameters corresponding to the second LCP rule, and the first condition is met, the second LCP rule is modified, and the LCP processing is performed on the data with the specific transmission requirement based on the modified second LCP rule.

For example, in the case that the first configuration information includes parameters corresponding to the first LCP rule, and the first condition is met, the LCP processing is performed on the data with the specific transmission requirement based on the first LCP rule.

In some embodiments, modifying the second LCP rule includes modifying the token bucket size and/or a PBR of an LCH corresponding to the data, or modifying a mapping relationship between the LCH and the resource.

In some embodiments, modifying the token bucket size of the LCH corresponding to the data includes: increasing the token bucket size of the LCH corresponding to the data with the specific transmission requirement, or setting the token bucket size of the LCH corresponding to the data with the specific transmission requirement as infinity.

For example, the terminal device temporarily modifies the token bucket size of at least one LCH corresponding to the ADU to ensure the ADU associated with the at least one LCH to be multiplexed with priority.

In some embodiments, modifying the PBR of the LCH corresponding to the data includes: increasing the PBR of the LCH corresponding to the data with the specific transmission requirement, or setting the PBR of the LCH corresponding to the data with the specific transmission requirement as infinity.

For example, the terminal device temporarily modifies the PBR of at least one LCH corresponding to the ADU as infinity to ensure the ADU associated with the at least one LCH to be multiplexed with priority.

In some embodiments, the modified mapping relationship between the LCH and the resource includes that the LCH corresponding to the data with the specific transmission requirement is mapped with priority onto the first resource in the case that a plurality of LCHs are to be mapped onto the first resource, and a first LCH in the plurality of LCHs is the LCH corresponding to the data with the specific transmission requirement.

In some embodiments, the first LCP rule includes at least one of: the token bucket size of the LCH corresponding to the data with the specific transmission requirement is infinite; or the LCH corresponding to the data with the specific transmission requirement is mapped with priority onto the first resource in the case that a plurality of LCHs are to be mapped onto the first resource, and a first LCH in the plurality of LCHs is the LCH corresponding to the data with the specific transmission requirement.

In some embodiments, performing the first processing operation on the data in response to the first condition being met includes:
modifying a second MAC packetization mode, and packetizing the data using the modified second MAC packetization mode, such that an uplink grant resource includes the data; or
packetizing the data using the first MAC packetization mode, such that an uplink grant resource includes the data.

For example, in the case that the first configuration information only includes parameters corresponding to the second MAC packetization mode, and the first condition is met, the second MAC packetization mode is modified, and the packetization is performed on the data with the specific transmission requirement based on the modified second MAC packetization mode.

For example, in the case that the first configuration information includes parameters corresponding to the first MAC packetization mode, and the first condition is met, the packetization is performed on the data with the specific transmission requirement using the first MAC packetization mode.

In some embodiments, the modified second MAC packetization mode or the first MAC packetization mode includes that the data with the specific transmission requirement is multiplexed with priority in the uplink grant resource. That is, the data with the specific transmission requirement is packeted with priority.

For example, in the case that the second LCP rule is not modified, the data with the specific transmission requirement is multiplexed in the uplink grant resource to transmit with priority using the first MAC packetization mode or the modified second MAC packetization mode.

In some embodiments, the second processing operation is activated by default, activated based on a condition, activated in the case that the first LCH parameters are not configured, deactivated in the case that the first LCH parameters are configured, or activated periodically.

In some embodiments of the present disclosure, S210 includes:
performing a second processing operation on the data in response to a second condition being met.

For example, the MAC layer of the terminal device performs the second processing operation on the data in response to the second condition being met.

In some embodiments, the second condition includes, but is not limited to at least one of:
the MAC layer of the terminal device receives third indication information from the first layer of the terminal device, wherein the third indication information indicates that the data is the data with the non-specific transmission requirement, or the third indication information is designed to instruct to perform the second processing operation;
the buffer of the terminal device contains no data with the specific transmission requirement;
the transmission of the data with the specific transmission requirement is completed; the size of the available resource is greater than or equal to the amount of the data with the specific transmission requirement;
the LCH parameters corresponding to the data with the specific transmission requirement are matched with the amount of the data with the specific transmission requirement; the currently used LCH parameters are matched with the amount of the data with the specific transmission requirement;
fourth indication information is received form the network device, wherein the fourth indication information is designed to disable the first processing operation;
the transmission delay of the data with the specific transmission requirement is less than or equal to the first delay threshold;
the transmission delay of the data with the non-specific transmission requirement is less than or equal to the second delay threshold;
a duration of enabling the first processing operation reaches a first duration;
a duration of disabling the second processing operation reaches a fourth duration; or
an amount of to-be-transmitted data with the specific transmission requirement is less than a first amount threshold.

In some embodiments, that the buffer of the terminal device contains no data with the specific transmission requirement includes at least one of: the transmission of the data with the specific transmission requirement is completed, the processing of the data with the specific transmission requirement is completed, for example, the LCP processing is performed on the data with the specific transmission requirement, the ACK feedback of the data with the specific transmission requirement is received, the MAC PDU packetization is performed on the data with the specific transmission requirement, or the LCH mapping or the resource allocation is performed on the data with the specific transmission requirement.

In some embodiments, that the transmission of the data with the specific transmission requirement is completed includes: no data with the specific transmission requirement that is not transmitted is present in the lower layer of the terminal device, no data with the specific transmission requirement that is transmitted improperly is present in the terminal device, or no data with the specific transmission requirement for which the ACK is not received is present in the terminal device.

In some embodiments, the size of the available resource being greater than or equal to the amount of the data with the specific transmission requirement means that the available resource is sufficient. In this case, the second processing operation is performed on the data, such that the data with the specific transmission requirement is allocated with the sufficient resource to some extent, and the transmission requirement of the data with the specific transmission requirement is met.

In some embodiments, that the LCH parameters corresponding to the data with the specific transmission requirement are matched with the amount of the data with the specific transmission requirement includes: the first configuration information only includes the second LCH parameters, and the token bucket size of the LCH configured based on the second LCH parameters is greater than or equal to the amount of the data with the specific transmission requirement; or the first configuration information includes the first LCH parameters, and the token bucket size of the LCH configured based on the first LCH parameters is greater than or equal to the amount of the data with the specific transmission requirement.

In some embodiments, that the transmission delay of the data with the specific transmission requirement is less than or equal to the first delay threshold means that the remaining transmission time of the data with the specific transmission requirement is more. Thus, the second processing operation is performed on the data, and the delay requirement of the data with the specific transmission requirement is met to some extent.

In some embodiments, that the amount of the to-be-transmitted data with the specific transmission requirement is less than the first amount threshold means that the to-be-transmitted data with the specific transmission requirement is less, and thus the transmission requirement of the data with the specific transmission requirement is met to some extent by performing the second processing operation.

In some embodiments, the terminal device enables or disables the first processing operation periodically.

For example, for periodically enabling the first processing operation, a timer is periodically started, and a duration of the timer is a first duration. The first processing operation is disabled in response to expiration of the timer. Furthermore, the second processing operation is enabled in response to disabling of the first processing operation.

In some embodiments, the third duration is predefined, configured by the network device, or determined by the terminal device.

In some embodiments, that the first processing operation is enabled or disabled based on the timer is applicable to periodically transmitted data.

In some embodiments, the terminal device enables or disables the second processing operation periodically.

For example, for periodically disabling the second processing operation, a timer is periodically started, and a duration of the timer is a fourth duration. The second processing operation is disabled in the running of the timer, and the second processing operation is enabled in response to expiration of the timer. Furthermore, the first processing operation is disabled in response to enabling of the second processing operation.

In some embodiments, the fourth duration is predefined, configured by the network device, or determined by the terminal device.

In conjunction with FIG. 3, the whole process of the above first embodiments is illustrated. As shown in FIG. 3, the whole process includes at least some of the following processes.

In S211, a network device transmits first configuration information to a terminal device. For detailed descriptions of the first configuration information, reference may be made to related descriptions of the above embodiments, which are not described herein.

In S212, the terminal device performs a first processing operation in response to a first condition being met.

For example, the LCP processing process is performed based the first LCP rule, the MAC PDU packetization is performed using the first MAC packetization mode, or the like.

In S213, the terminal device transmits a packeted MAC PDU to the network device.

In summary, in the first embodiments, the terminal device performs different processing operations on the data in different conditions. For example, the data is processed based on the first processing operation in the case that there is the data with the high QoS requirement or high importance, and the data is processed based on the second processing operation without the data with the high QoS requirement or high importance, such that the data with the high QoS requirement or high importance is processed or transmitted with priority.

### Second Embodiments

In some embodiments, the second embodiments are applicable to a scenario of mapping data with different transmission requirements (for example, the QoS requirement or importance) to different DRBs, LCHs, or PDCPs, or are applicable to a scenario of mapping data with the same transmission requirement (for example, the QoS requirement or importance) to different DRBs, LCHs, or PDCPs.

In the following embodiments of the present disclosure, the method 200 further includes:
receiving, by the terminal device, second configuration information from the network device, wherein the second configuration information includes LCH parameters corresponding to the data.

It should be understood that the second configuration information is configured by any downlink signaling, for an example but not a limitation, RRC signaling. In some embodiments, in the case that the second configuration information is configured by the RRC signaling, the second configuration information is also referred to as an RRC configuration parameter.

In some embodiments, the second configuration information includes the second LCH parameters. For detailed implementations of the second LCH parameters, reference may be made to related descriptions in the first embodiments, which are not described herein.

In some embodiments, the second LCH parameters include at least one of: the LCP, the PBR, the BSD, or the second LCH mapping restriction.

In some embodiments, the second configuration information includes first CG resource configuration. The first CG resource configuration is designed to configure a first CG resource. The first CG resource is associated with an LCH corresponding to the data with the specific transmission requirement, or the first CG resource is only associated with an LCH corresponding to the data with the specific transmission requirement by the LCH mapping restriction. Alternatively, the first CG resource is associated with the data with the specific transmission requirement, or the first CG resource is only configured to transmit the data with the specific transmission requirement.

In some embodiments, the terminal device processes and/or transmits the data with the specific transmission requirement based on the second LCH parameters and the first CG resource configuration.

In some embodiments, the terminal device processes and/or transmits the data with the non-specific transmission requirement based on the second LCH parameters.

In some embodiments, the first CG resource includes at least one of a type-1 CG resource, or a type-2 CG resource.

In some embodiments, the first CG resource configuration is mandatory configuration.

For example, the network device must configure the first CG resource configuration in configuring the LCH parameters.

In some embodiments, the first CG resource configuration is optional configuration. That is, the second configuration information does not necessarily include the first CG resource configuration.

In some embodiments, the terminal device self-activates the first CG resource, or activates the first CG resource based on the condition.

In some embodiments, the terminal device activates the first CG resource in the case that the network device configures the first CG resource configuration.

In some embodiments, the terminal device determines whether to enable to self-activate the first CG resource based on fifth indication information from the network device, whether to activate the first CG resource based on a condition, or whether to activate the first CG resource periodically.

In some embodiments, the fifth indication information is carried in the second configuration information, or indicated by a signaling. For example, the second configuration information is configured by the RRC signaling, and the fifth indication information is indicated by the DCI or the MAC CE.

In some embodiments, the first CG resource or the first CG resource configuration is used based on a duration, and the duration corresponds to the timer.

In some embodiments, the second configuration information further includes a fifth duration indicating a using or enabling duration of the first CG resource. For example, the first CG resource or the first CG resource configuration is used within the fifth duration, and is not used upon run-out of the fifth duration.

In some embodiments, the fifth duration is configured by the network device, for example, configured by the first configuration information, configured by single signaling, predefined, that is, without indication of the network device, or determined by the terminal device.

In some embodiments, the second configuration information further includes a sixth duration indicating an non-use or disabling duration of the first CG resource. For example, the first CG resource or the first CG resource configuration is not used within the sixth duration, and is used upon run-out of the sixth duration.

In some embodiments, the sixth duration is configured by the network device, for example, configured by the first configuration information, configured by single signaling, predefined, that is, without indication of the network device, or determined by the terminal device.

In some embodiments, the data is acquired by a first layer of the terminal device from a higher layer of the terminal device, and the higher layer of the terminal device is above the first layer.

In some embodiments, the first layer of the terminal device includes, but is not limited to at least one of: the SDAP layer, the PDCP layer, or the MAC layer.

In some embodiments, the first layer of the terminal device determines whether the data is the data with the specific transmission requirement upon acquiring the data.

In some embodiments, the first layer of the terminal device determines whether the data is the data with the specific transmission requirement based on indication of the higher layer of the terminal device, or self-determines whether the data is the data with the specific transmission requirement.

In some embodiments, the first layer of the terminal device determines to activates the first CG resource in the case that the data is the data with the specific transmission requirement. In some embodiments, the first layer of the terminal device transmits sixth indication information to the MAC layer of the terminal device. The sixth indication information indicates that the data is the data with the specific transmission requirement, or the sixth indication information is designed to instruct to activate the first CG resource.

In some embodiments, the first layer of the terminal device further determines to deactivate the first CG resource in the case that the data is the data with the non-specific transmission requirement. In some embodiments, the first layer of the terminal device transmits seventh indication information to the MAC layer of the terminal device. The seventh indication information indicates that the data is the data with the non-specific transmission requirement, or the seventh indication information is designed to instruct to deactivate the first CG resource.

In some embodiments, in the case that the terminal device determines that the data is the data with the specific transmission requirement, the terminal device self-activates the first CG resource, or activates the first CG resource based on the condition, or transmits indication information to the network device to indicate that the data with the specific transmission requirement is present. The indication information is configured for the network device to determine whether to activate the first CG resource, or the indication information is configured for the network device to configure the first CG resource configuration.

For example, in the case that the network device configures the first CG resource configuration for the terminal device, the network device instructs to activate the first CG resource configuration based on the fifth indication information.

For example, in the case that the network device does not configure the first CG resource configuration for the terminal device, the network device configures the first CG resource configuration for the terminal device in response to receiving the indication information from the terminal device.

In some embodiments of the present disclosure, S210 includes:
activating, by the terminal device, the first CG resource in response to the third condition being met. That is, the terminal device activates the first CG resource based on the condition.

For example, the MAC layer of the terminal device activates the first CG resource in response to the third condition being met.

In some embodiments, the third condition includes at least one of:
the MAC layer of the terminal device receives sixth indication information from the first layer of the terminal device, wherein the sixth indication information indicates that the data is the data with the specific transmission requirement, or the sixth indication information is designed to instruct to activate the first CG resource;
the buffer of the terminal device includes the data with the specific transmission requirement; the transmission of the data with the specific transmission requirement is not completed;
the size of the available resource is less than the amount of the data with the specific transmission requirement;
the LCH parameters corresponding to the data with the specific transmission requirement are not matched with the amount of the data with the specific transmission requirement;
the currently used LCH parameters are not matched with the amount of the data with the specific transmission requirement;
the transmission delay of the data with the specific transmission requirement is greater than the third delay threshold;
the transmission delay of the data with the non-specific transmission requirement is greater than the fourth delay threshold;
the duration of deactivating the first CG resource based on the condition reaches a sixth duration; or
the amount of the to-be-transmitted data with the specific transmission requirement is greater than a second amount threshold.

For the case that the buffer of the terminal device includes the data with the specific transmission requirement, reference may be made to related descriptions in the first embodiments, which are not described herein.

For the case that the transmission of the data with the specific transmission requirement is not completed, reference may be made to related descriptions in the first embodiments, which are not described herein.

In some embodiments, the first CG resource is activated in the case that the size of the available resource is less than the amount of the data with the specific transmission requirement, such that the data with the specific transmission requirement is allocated with the sufficient resource, and the transmission requirement of the data with the specific transmission requirement is met.

In some embodiments, that the LCH parameters corresponding to the data with the specific transmission requirement are not matched with the amount of the data with the specific transmission requirement includes that the token bucket size of the LCH configured based on the second LCH parameters is less than the amount of the data with the specific transmission requirement.

In some embodiments, that the transmission delay of the data with the specific transmission requirement is greater than the third delay threshold means that the remaining transmission time of the data with the specific transmission requirement is less. In this case, the first CG resource is activated, such that the data with the specific transmission requirement is transmitted with priority to meet the delay requirement of the data.

In some embodiments, the third delay threshold is predefined, configured by the network device, for example, configured in the second configuration information, or determined by the terminal device.

In some embodiments, the third delay threshold is a PDB.

In some embodiments, the transmission delay of the data with the non-specific transmission requirement being greater than the fourth delay threshold means that a remaining transmission time of the data with the non-specific transmission requirement is less. In this case, the first CG resource is activated, such that the data with the specific transmission requirement is transmitted with priority to meet the delay requirement of the data.

In some embodiments, the fourth delay threshold is predefined, configured by the network device, for example, configured in the second configuration information, or determined by the terminal device.

In some embodiments, the fourth delay threshold is a PDB.

In some embodiments, the terminal device enables or disables the first CG resource periodically, or enables or disables the first CG resource configuration periodically.

For example, for periodically disabling the first CG resource, a timer is periodically started, and a duration of the timer is a sixth duration. The first CG resource is disabled in the running of the timer, and the first CG resource is enabled in response to expiration of the timer.

In some embodiments, that the amount of the to-be-transmitted data with the specific transmission requirement is greater than the second amount threshold means that the to-be-transmitted data with the specific transmission requirement is greater. In this case, the first CG resource is activated, such that the data with the specific transmission requirement is allocated with the sufficient resource, and the transmission requirement of the data with the specific transmission requirement is met.

In some embodiments, the second amount threshold is predefined, configured by the network device, for example, configured in the second configuration information, or determined by the terminal device.

In some embodiments of the present disclosure, the method 200 further includes:
transmitting the data with the specific transmission requirement using the first CG resource in response to the first CG resource being activated.

In the case that the first CG resource is activated, the data with the specific transmission requirement is transmitted using the first CG resource, such that the available transmission resource for transmitting the data with the specific transmission requirement is increased, and the transmission requirement of the data is facilitated to be met.

In some embodiments, the first CG resource is deactivated by default, deactivated based on the condition, or deactivated periodically.

In some embodiments of the present disclosure, S210 further includes:
deactivating the first CG resource in response to a fourth condition being met. That is, the first condition is deactivated based on the condition.

For example, in the case that the fourth condition is met, the MAC layer of the terminal device deactivates the first CG resource.

In some embodiments, the fourth condition includes at least one of:
the MAC layer of the terminal device receives seventh indication information from the first layer of the terminal device, wherein the seventh indication information indicates that the data is the data with the non-specific transmission requirement, or the seventh indication information is designed to instruct to deactivate the first CG resource;
the buffer of the terminal device contains no data with the specific transmission requirement;
the transmission of the data with the specific transmission requirement is completed; the size of the available resource is greater than or equal to the amount of the data with the specific transmission requirement;
the LCH parameters corresponding to the data with the specific transmission requirement are matched with the amount of the data with the specific transmission requirement; the currently used LCH parameters are matched with the amount of the data with the specific transmission requirement;
eighth indication information is received from the network device, wherein the eighth indication information is designed to instruct to deactivate the first CG resource;
the transmission delay of the data with the specific transmission requirement is less than or equal to the third delay threshold;
the transmission delay of the data with the non-specific transmission requirement is less than or equal to the fourth delay threshold;
the duration of activating the first CG resource based on the condition reaches the fifth duration; or
the amount of the to-be-transmitted data with the specific transmission requirement is less than or equal to the second amount threshold.

For the case that the buffer of the terminal device contains no data with the specific transmission requirement, reference may be made to related descriptions in the first embodiments, which are not described herein for brevity.

For the case that the transmission of the data with the specific transmission requirement is completed, reference may be made to related descriptions in the first embodiments, which are not described herein for brevity.

In some embodiments, the size of the available resource being greater than or equal to the amount of the data with the specific transmission requirement means that the available resource is sufficient. In this case, the data is transmitted in the case that the first CG resource is not activated, such that the data with the specific transmission requirement is allocated with the sufficient resource to some extent, and the transmission of the data with the specific transmission requirement is ensured.

In some embodiments, that the LCH parameters corresponding to the data with the specific transmission requirement are matched with the amount of the data with the specific transmission requirement includes: the token bucket size of the LCH configured based on the second LCH parameters is greater than or equal to the amount of the data with the specific transmission requirement.

In some embodiments, the currently used LCH parameters are the second LCH parameters.

In some embodiments, that the currently used LCH parameters are matched with the amount of the data with the specific transmission requirement includes: the token bucket size of the LCH configured based on the second LCH parameters is less than the amount of the data with the specific transmission requirement.

In some embodiments, that the transmission delay of the data with the specific transmission requirement is less than or equal to the third delay threshold means that the remaining transmission time of the data with the specific transmission requirement is more. In this case, the data is transmitted in the case that the first CG resource is not used, such that the delay requirement of the data with the specific transmission requirement is met to some extent.

In some embodiments, the third delay threshold is a PDB.

In some embodiments, the transmission delay of the data with the non-specific transmission requirement being less than or equal to the fourth delay threshold means that a remaining transmission time of the data with the non-specific transmission requirement is more. In this case, the data is transmitted in the case that the first CG resource is not used, and the resource is allocated with priority to the data with the specific transmission requirement to ensure the delay requirement of the data with the specific transmission requirement.

In some embodiments, the fourth delay threshold is a PDB.

In some embodiments, that the amount of the to-be-transmitted data with the specific transmission requirement is less than the second amount threshold means that the to-be-transmitted data with the specific transmission requirement is less. In this case, the data is transmitted in the case that the first CG resource is not used, such that the data with the specific transmission requirement is allocated with the sufficient resource to some extent, and the transmission of the data with the specific transmission requirement is ensured.

In some embodiments, the terminal device enables or disables the first CG resource periodically, or enables or disables the first CG resource configuration periodically.

For example, for periodically enabling the first CG resource, a timer is periodically started, and a duration of the timer is a fifth duration. The first CG resource is disabled in response to expiration of the timer.

In summary, in the second embodiments, the terminal device activates or deactivates the first CG resource based on the transmission requirement information of the data, such that different transmission requirements of the data are facilitated to be met. For example, the first CG resource is activated in response to the data with the high QoS requirement or high importance, such that the available transmission resource for transmitting the data with the specific transmission requirement is increased. The first CG resource is deactivated without the data with the high QoS requirement or high importance, such that the power consumption of the terminal device is balanced.

It should be understood that the above first embodiments and the second embodiments are implemented separately or implemented by combining with each other. For example, the second configuration information includes the first LCH parameters, the second LCH parameters, and the first CG resource configuration, and the terminal device activates the first CG resource and processes the data based on the first processing operation in the case that the third condition is met.

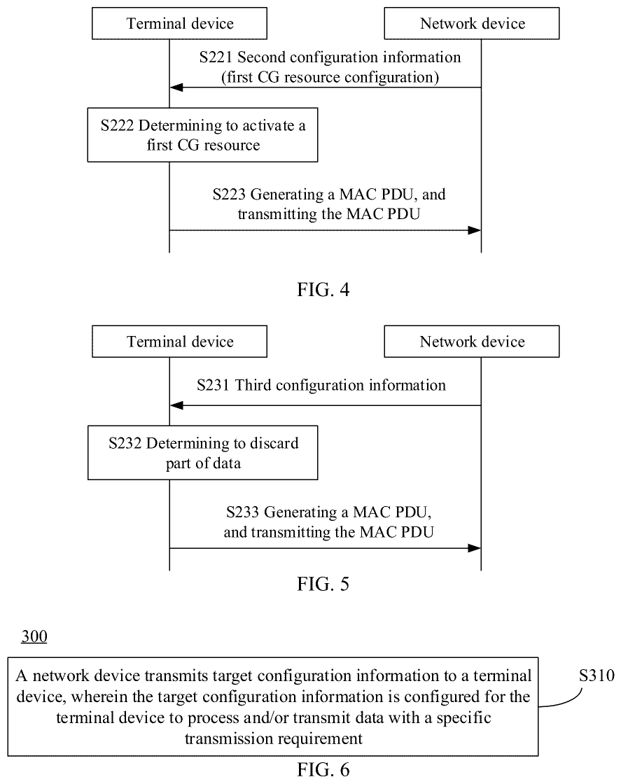

In conjunction with FIG. 4, the whole process of the above second embodiments is illustrated. As shown in FIG. 4, the whole process includes at least some of the following processes.

In S221, a network device transmits second configuration information to a terminal device. For detailed descriptions of the second configuration information, reference may be made to related descriptions of the above embodiments, which are not described herein.

In S222, the terminal device activates the first CG resource in determining that a third condition is met.

For example, the MAC packetization is performed based on the activated first CG resource to generate the MAC PDU.

In S223, the terminal device transmits a packeted MAC PDU to the network device.

In summary, in the second embodiments, the terminal device activates or deactivates the first CG resource based on the transmission requirement information of the data, such that different transmission requirements of the data are facilitated to be met. For example, the first CG resource is activated in response to the data with the high QoS requirement or high importance, such that the available transmission resource for transmitting the data with the specific transmission requirement is increased. The first CG resource is deactivated without the data with the high QoS requirement or high importance, such that the power consumption of the terminal device is balanced.

It should be understood that the above first embodiments and the second embodiments are implemented separately or implemented in a combination with each other. For example, the second configuration information includes the first LCH parameters, the second LCH parameters, and the first CG resource configuration, and the terminal device activates the first CG resource and processes the data based on the first processing operation in the case that the third condition is met.

### Third Embodiments

In some embodiments, the first embodiments are applicable to a scenario of mapping data with different transmission requirements (for example, the QoS requirement or importance) to different DRBs, LCHs, or PDCPs, or a scenario of mapping data with the same transmission requirement (for example, the QoS requirement or importance) to different DRBs, LCHs, or PDCPs.

In some embodiments of the present disclosure, the method 200 further includes:
receiving, by the terminal device, third configuration information from the network device, wherein the third configuration information includes second LCH parameters.

For detailed implementations of the second LCH parameters, reference may be made to related descriptions in the first embodiments, which are not described herein.

In some embodiments, the second LCH parameters include at least one of: the LCP, the PBR, the BSD, or the LCH mapping restriction.

In some embodiments, the third configuration information further includes a second correspondence indicating a correspondence between at least one of the DRB, the LCH, or the PDCP layer and the transmission requirement information of the data.

For example, the second correspondence is a correspondence of the DRB and the QoS requirement or the importance, a correspondence of the LCH and the QoS requirement or the importance, or a correspondence of the PDCP layer and the QoS requirement or the importance.

Thus, the terminal device determines the QoS requirement or the importance that can be met by the DRB, the LCH, or the PDCP layer based on the second correspondence, and thus maps the data with different QoS requirements or importance to corresponding DRBs, LCHs, or PDCP layers, such that the QoS requirement or the importance of the data is met.

In some embodiments, the third configuration information further includes second parameter information indicating transmission requirement parameters of data associated with at least one of the DRB, the LCH, or the PDCP layer.

For example, the second parameter information includes a QoS requirement parameter or an importance parameter associated with the DRB, and/or a QoS requirement parameter or an importance parameter associated with the LCH, and/or a QoS requirement parameter or an importance parameter associated with the PDCP layer.

Thus, the terminal determines the QoS requirement or the importance that can be met by the DRB, the LCH, or the PDCP layer based on the second parameter information, and further maps the data with different QoS requirements or importance to corresponding DRBs, LCHs, or PDCP layers, such that the QoS requirement or the importance of the data is met.

In some embodiments, the third configuration information further includes PDCP parameters, for example, a discard timer corresponding to the data. The data is deleted in response to expiration of the discard timer.

In some embodiments, the data with the specific transmission requirement corresponds to a first discard timer, and the data with the non-specific transmission requirement corresponds to a second discard timer. A duration of the first discard timer is different from a duration of the second discard timer.

As an example, the duration of the first discard timer is greater than the duration of the second discard timer.

In some embodiments, the third configuration information further includes parameters corresponding to a third processing operation.

In some embodiments of the present disclosure, S210 includes:
performing, by the terminal device, the third processing operation on the data based on the transmission requirement information of the data in the buffer of the terminal device.

In some embodiments, the buffer of the terminal device includes a PDCP buffer and/or a RLC buffer.

In some embodiments, the third processing operation includes a delete operation and/or a submit to lower layer operation.

In some embodiments, the third processing operation includes a prioritized processing operation and a processing operation with low priority. For example, the data with the specific transmission requirement corresponds to the prioritized processing operation, and the data with the non-specific transmission requirement corresponds to the processing operation with low priority.

In the third embodiments, the data is acquired by a second layer of the terminal device from the higher layer of the terminal device, and the higher layer of the terminal device is above the second layer.

In some embodiments, the second layer of the terminal device includes, but is not limited to at least one of: the SDAP layer, the PDCP layer, the RLC layer, or the MAC layer.

In some embodiments, the second layer of the terminal device determines whether the data is the data with the specific transmission requirement upon acquiring the data.

In some embodiments, the second layer of the terminal device determines whether the data is the data with the specific transmission requirement based on indication of the higher layer of the terminal device, or self-determines whether the data is the data with the specific transmission requirement.

In some embodiments, the second layer of the terminal device determines to perform the third processing operation in the case that the data is the data with the specific transmission requirement.

In some embodiments, the second layer of the terminal device transmits ninth indication information to a third layer of the terminal device. The ninth indication information indicates that the data is the data with the specific transmission requirement, or the second indication information is designed to instruct to perform the third processing operation.

In some embodiments, the third processing operation includes, but is not limited to at least one of:
deleting the data with the non-specific transmission requirement in the buffer in the terminal device;
deleting data with the transmission delay exceeding a fifth delay threshold in the buffer in the terminal device;
deleting the data with the non-specific transmission requirement of which the transmission delay exceeds a sixth delay threshold in the buffer in the terminal device;
prioritizing the data with the specific transmission requirement, a HARQ of the data with the specific transmission requirement, or the grant (for example, the uplink grant or the downlink grant) of the data with the specific transmission requirement;
assigning a low priority to the data with the non-specific transmission requirement, a HARQ of the data with the non-specific transmission requirement, or the grant corresponding to the data with the non-specific transmission requirement;
skipping the data with the non-specific transmission requirement, the HARQ of the data with the non-specific transmission requirement, or the grant corresponding to the data with the non-specific transmission requirement;
prioritizing submitting the data with the specific transmission requirement to the lower layer of the terminal device;
submitting the data with the non-specific transmission requirement to the lower layer of the terminal device with low priority;
prioritizing transmitting the data with the specific transmission requirement to the opposite end; or
transmitting the data with the non-specific transmission requirement to the opposite end with low priority.

In some embodiments, parameters corresponding to the third processing operation include the fifth delay threshold and/or the sixth delay threshold.

In some embodiments, the third processing operation is activated by default or activated based on a condition, that is, the terminal device performs the third processing operation in the specific condition.

In some embodiments, the third processing operation is performed by a third layer of the terminal device.

In some embodiments, the third layer of the terminal device includes at least one of: the PDCP layer, the RLC layer, or the MAC layer.

For example, the second layer of the terminal device is the SDAP layer, and the third layer of the terminal device is the PDCP layer.

For example, the second layer of the terminal device is the PDCP layer, and the third layer of the terminal device is the RLC layer.

For example, the second layer of the terminal device is the RLC layer, and the third layer of the terminal device is the MAC layer.

For example, the second layer of the terminal device is the PDCP layer, and the third layer of the terminal device is the MAC layer.

In some embodiments, the third processing operation is performed in the case that a fifth condition is met.

In some embodiments, the fifth condition includes, but is not limited to at least one of:
the third layer of the terminal device receives the ninth indication information from the second layer of the terminal device;
the buffer of the terminal device includes the data with the specific transmission requirement; transmission of the data with the specific transmission requirement in the buffer of the terminal device is not completed;
the amount of the data in the buffer of the terminal device is greater than the third amount threshold;
the size of the available resource is less than the amount of the data with the specific transmission requirement;
the LCH parameters corresponding to the data with the specific transmission requirement are not matched with the amount of the data with the specific transmission requirement;
the currently used LCH parameters are not matched with the amount of the data with the specific transmission requirement;
the transmission delay of the data with the specific transmission requirement is greater than the fifth delay threshold;
the transmission delay of the data with the non-specific transmission requirement is greater than the sixth delay threshold;
the PDB requirement of the data with the specific transmission requirement is higher than a first PDB threshold;
the amount of the data with the non-specific transmission requirement is greater than a fourth amount threshold;
a buffer delay of the data with the specific transmission requirement is greater than a seventh delay threshold; or
a buffer amount of the data with the specific transmission requirement is greater than a fifth amount threshold.

For the case that the buffer of the terminal device includes the data with the specific transmission requirement, reference may be made to related descriptions in the first embodiments, which are not described herein for brevity.

For the case that the transmission of the data with the specific transmission requirement is not completed, reference may be made to related descriptions in the first embodiments, which are not described herein for brevity.

In some embodiments, the amount of the data in the buffer of the terminal device being greater than the third amount threshold indicates that the amount in the buffer is excessive great. In this case, the third processing operation is performed, such that the data with the specific transmission requirement is processed or transmitted with priority.

In some embodiments, the size of the available resource being less than the amount of the data with the specific transmission requirement means that the available resource is not sufficient. Thus, the third processing operation is performed, such that the data with the specific transmission requirement is transmitted with priority.

In some embodiments, the third amount threshold is predefined, configured by the network device, for example, configured in the third configuration information, or determined by the terminal device.

In some embodiments, that the LCH parameters corresponding to the data with the specific transmission requirement are not matched with the amount of the data with the specific transmission requirement includes the token bucket size of the LCH configured based on the second LCH parameters is less than the amount of the data with the specific transmission requirement.

In some embodiments, the currently used LCH parameters are LCH parameters configured by the network device, for example, the second LCH parameters.

In some embodiments, that the currently used LCH parameters are not matched with the amount of the data with the specific transmission requirement includes: the token bucket size of the LCH configured based on the second LCH parameters is less than the amount of the data with the specific transmission requirement.

In some embodiments, the transmission delay of the data with the specific transmission requirement being greater than the fifth delay threshold means that a remaining transmission time of the data with the specific transmission requirement is less. In this case, the third processing operation is performed, such that the data with the specific transmission requirement is transmitted with priority to meet the delay requirement of the data.

In some embodiments, the fifth delay threshold is predefined, configured by the network device, for example, configured in the third configuration information, or determined by the terminal device.

In some embodiments, the transmission delay of the data with the non-specific transmission requirement being greater than the sixth delay threshold means that a remaining transmission time of the data with the non-specific transmission requirement is less. That is, the delay requirement is not met even if the data with the non-specific transmission requirement is transmitted immediately. Thus, the third processing operation is performed to ensure the transmission of the data with the specific transmission requirement is prioritized.

In some embodiments, the sixth delay threshold is predefined, configured by the network device, for example, configured in the third configuration information, or determined by the terminal device.

In some embodiments, the PDB requirement of the data with the specific transmission requirement being higher than the first PDB threshold means that a delay tolerance of the data is low. In this case, the third processing operation is performed to ensure the priority transmission of the data with the specific transmission requirement.

In some embodiments, the first PDB threshold is predefined, configured by the network device, for example, configured in the third configuration information, or determined by the terminal device.

In some embodiments, the amount of the data with the non-specific transmission requirement being greater than the fourth amount threshold means that a space occupied by the data with the non-specific transmission requirement is large. In this case, the third processing operation is performed to ensure the priority transmission of the data with the specific transmission requirement.

In some embodiments, the fourth amount threshold is predefined, configured by the network device, for example, configured in the third configuration information, or determined by the terminal device.

It should be understood that the buffer delay of the data indicates a duration of occupying the buffer by the data. For example, the data is in the PDCP buffer or the RLC buffer, and the lower layer of the PDCP layer does not transmit the data. Alternatively, the data is in the PDCP buffer or the RLC buffer, and the lower layer of the PDCP layer has not successfully transmitted the data. Alternatively, the data is in the PDCP buffer or the RLC buffer, and the terminal device has not received the ACK of the data. Alternatively, the data is still in the PDCP buffer or the RLC buffer.

As described above, the transmission delay of the data refers to a duration from a start time of the data to a time at which the data is transmitted to the opposite end or is successfully received by the opposite end (for example, receives the ACK from the opposite end).

In some embodiments, the start time of the data refers to a time at which the data arrives or is stored in the buffer of the terminal device, or a time at which the data is generated, or a time at which the data arrives an air interface, or a time at which the data reaches the PDCP layer, or a start time at which the data is transmitted in the lower layer of the terminal device.

For example, the transmission delay of the data is a duration from generation of the data to reception of the data by the opposite end, or a duration from arrival of the data to the PDCP layer to successful reception of the data by the opposite end. For example, a duration in which the data is transmitted by the lower layer of the terminal device but feedback information of the opposite end is not received is construed as the transmission delay of the data, or a duration consumed by transmission, or a part of the transmission delay.

It should be understood that in the case that an application layer of the terminal device is considered, the buffer delay of data and the transmission delay of data is described in terms of the application layer of the terminal device. Alternatively, in the case that a non-access layer (NAS) of the terminal device is considered, the buffer delay of data and the transmission delay of data is described in terms of the application layer of the terminal device.

In some embodiments, the buffer delay of the data with the specific transmission requirement being greater than the seventh delay threshold means that a duration of occupying the buffer by the data is great. In this case, the third processing operation is performed to ensure the priority transmission of the data with the specific transmission requirement.

In some embodiments, the seventh delay threshold is predefined, or configured by the network device, for example, configured in the third configuration information, or determined by the terminal device.

In some embodiments, the buffer amount of the data refers to an amount of the data in the PDCP buffer or the RLC layer.

It should be understood that in the case that an application layer of the terminal device is considered, the buffer amount of the data is described in terms of the application layer of the terminal device, and the amount of the data is described in terms of the lower layer of the terminal device. Alternatively, in the case that the NAS of the terminal device is considered, the buffer amount of the data is described in terms of the application layer of the terminal device, and the amount of the data is described in terms of an access layer (AS) of the terminal device.

In some embodiments, the buffer amount of the data with the specific transmission requirement being greater than the fifth amount threshold means that the amount of the data with the specific transmission requirement in the PDCP buffer or the RLC layer is greater. In this case, the third processing operation is performed to ensure the priority transmission of the data with the specific transmission requirement.

In some embodiments, the fifth amount threshold is predefined, or configured by the network device, for example, configured in the third configuration information, or determined by the terminal device.

In conjunction with FIG. 5, the whole process of the above third embodiments is illustrated. As shown in FIG. 5, the whole process includes at least some of the following processes.

In S231, a network device transmits third configuration information to a terminal device. For detailed descriptions of the third configuration information, reference may be made to related descriptions of the above embodiments, which are not described herein.

In S232, the terminal device performs a third processing operation in response to a fifth condition being met.

Upon the third processing operation being performed, the LCP processing and/or the MAC PDU packetization is performed on the data based on the second LCH parameters.

In S233, the terminal device transmits a packeted MAC PDU to the network device.

In summary, in the second embodiments, the terminal device performs different processing operations on the data in different conditions.

For example, the third processing operation is performed in the case that the fifth condition is met, and the processed data is further processed based on the second LCH parameters, such that the data with the high QoS requirement or high importance is processed or transmitted with priority.

In summary, the terminal device performs the first processing operation on the data based on the transmission requirement information of the data, such that the processing or transmission of the data with the specific transmission requirement is prioritized. Alternatively, the terminal device activates the first CG resource based on the transmission requirement information of the data, and the first CG resource is configured to transmit the data with the specific transmission requirement or is associated with the LCH corresponding to the data with the specific transmission requirement, which is equivalent to increment of the resource for transmitting the data with the specific transmission requirement, such that the transmission requirement of the data is facilitate to be met. Alternatively, the terminal device performs the third processing operation based on the transmission requirement information of the data, for example, deleting the data with the non-specific transmission requirement in the buffer, or the like, such that the priority processing or transmission of the data with the specific transmission requirement is ensured.

The method for wireless communication according to the embodiments of the present disclosure is described in detail in terms of the terminal device in the above description in conjunction with FIGS. 2 to 5, and the method for wireless communication according to some embodiments of the present disclosure is described in detail in terms of the network device hereinafter in conjunction with FIG. 6. It should be understood that the descriptions of the network device side correspond to the descriptions of the terminal device side, and for similar descriptions, reference may be made to the above descriptions, which are not repeated for avoidance of repetition.

FIG. 6 is a schematic diagram of a method 300 for wireless communication according to some embodiments of the present disclosure. As shown in FIG. 6, the method 300 includes at least some of the following processes.

In S310, a network device transmits target configuration information to a terminal device, wherein the target configuration information is configured for the terminal device to process and/or transmit data with a specific transmission requirement.

In some embodiments, the target configuration information includes the first configuration information, and the first configuration information includes the first LCH parameters and the second LCH parameters. The first LCH parameters are configured for the data with the specific transmission requirement, and the second LCH parameters are configured for the data with the non-specific transmission requirement.

In some embodiments, the first LCH parameters include parameters corresponding to the first processing operation, wherein the first processing operation includes at least one of: performing the LCP processing on the data using the first LCP rule; packetizing the data using the first MAC packetization mode; or performing the LCH mapping and/or the resource selection on the data using the first LCH mapping restriction.

In some embodiments, the second LCH parameters include parameters corresponding to a second processing operation, wherein the second processing operation includes at least one of: performing the LCP processing on the data using the second LCP rule; packetizing the data using the second MAC packetization mode; or performing the LCH mapping and/or the resource selection on the data using the second LCH mapping restriction.

In some embodiments, the first configuration information further includes:
the first correspondence, indicating the correspondence between at least one of the DRB, the LCH, or the PDCP layer and the transmission requirement information of the data; or
the first parameter information, indicating the transmission requirement parameters of the data associated with at least one of the DRB, the LCH, or the PDCP layer.

In some embodiments, the first configuration information further includes: the first indication information, indicating whether to activate the first LCH parameters, or whether to enable the first processing operation.

In some embodiments, the first configuration information further includes the first duration indicating the using or enabling duration of the first LCH parameters or the first processing operation. For example, the first LCH parameter or the first processing operation is used within the first duration, and the first LCH parameter or the first processing operation is not used or the second LCH parameter or the second processing operation is used upon run-out of the first duration.

In some embodiments, the first configuration information further includes the second duration indicating the using or enabling duration of the second LCH parameters or the second processing operation. For example, the second LCH parameter or the second processing operation is used within the second duration, and the second LCH parameter or the second processing operation is not used or the first LCH parameter or the first processing operation is used upon run-out of the second duration.

In some embodiments, the first configuration information further includes the third duration indicating the disabling or non-use duration (where the first LCH parameters or the first processing operation is not used) of the first LCH parameters or the first processing operation. For example, the first LCH parameter or the first processing operation is not used within the third duration, and the first LCH parameter or the first processing operation is used or the second LCH parameter or the second processing operation is not used upon run-out of the third duration.

In some embodiments, the first configuration information further includes the fourth duration indicating the non-use or disabling duration of the second LCH parameters or the second processing operation. For example, the second LCH parameters or the second processing operation is not used within the fourth duration, and the second LCH parameters or the second processing operation is used or the first LCH parameters or the first processing operation is not used upon run-out of the fourth duration. In some embodiments, the target configuration information includes the second configuration information, and the second configuration information includes the first CG resource configuration. The first CG resource configuration is designed to configure the first CG resource. The first CG resource is associated with the LCH corresponding to the data with the specific transmission requirement.

In some embodiments, the first CG resource includes at least one of the type-1 CG resource, or the type 2-CG resource.

In some embodiments, the second configuration information further includes: the fifth indication information, wherein the fifth indication information indicates whether to enable to self-activate the first CG resource, or whether to activate the first CG resource based on the condition.

In some embodiments, the second configuration information further includes the fifth duration indicating the using or enabling duration of the first CG resource. For example, the first CG resource or the first CG resource configuration is used within the fifth duration, and is not used upon run-out of the fifth duration.

In some embodiments, the second configuration information further includes the sixth duration indicating the non-use or disabling duration of the first CG resource. For example, the first CG resource or the first CG resource configuration is not used within the sixth duration, and is used upon run-out of the sixth duration. In some embodiments, the target configuration information includes the third configuration information, and the third configuration information includes parameters corresponding to the third processing operation.

In some embodiments, the third processing operation includes at least one of:
deleting the data with the non-specific transmission requirement in the buffer;
deleting the data with the transmission delay exceeding the fifth delay threshold in the buffer;
deleting the data with the non-specific transmission requirement of which the transmission delay exceeds the sixth delay threshold in the buffer;
prioritizing the data with the specific transmission requirement, the HARQ of the data with the specific transmission requirement, or the grant (for example, the uplink grant or the downlink grant) of the data with the specific transmission requirement;
assigning a low priority to the data with the non-specific transmission requirement, the HARQ of the data with the non-specific transmission requirement, or the grant corresponding to the data with the non-specific transmission requirement;
skipping the data with the non-specific transmission requirement, the HARQ of the data with the non-specific transmission requirement, or the grant corresponding to the data with the non-specific transmission requirement;
prioritizing submitting the data with the specific transmission requirement to the lower layer of the terminal device;
submitting the data with the non-specific transmission requirement to the lower layer of the terminal device with low priority;
prioritizing transmitting the data with the specific transmission requirement to the opposite end; or
transmitting the data with the non-specific transmission requirement to the opposite end with low priority.

In some embodiments, parameters corresponding to the third processing operation include the fifth delay threshold and/or the sixth delay threshold.

In some embodiments, the third configuration information is designed to configure at least one of:
the second correspondence, indicating the correspondence between at least one of the DRB, the LCH, or the PDCP layer and the transmission requirement information of the data;
the second parameter information, indicating transmission requirement parameters of data associated with at least one of the DRB, the LCH, or the PDCP layer; or
the discard timer corresponding to the data, wherein the data is deleted in response to expiration of the discard timer.

In some embodiments, the data with the specific transmission requirement corresponds to a first discard timer, and the data with the non-specific transmission requirement corresponds to a second discard timer. The duration of the first discard timer is different from the duration of the second discard timer.

The method for wireless communication according to the embodiments of the present disclosure is described in detail in terms of the terminal device and the network device in the above descriptions, and the method for wireless communication according to some embodiments of the present disclosure is described in detail in terms of interactions of the devices hereinafter.

In the first embodiments, the UE uses the first LCP rule, or performs the first MAC packetization mode, or uses the first LCH mapping restriction based on the QoS requirement or the importance of the media unit. The first embodiments are more applicable to a case of mapping media units/streams with different QoS requirements or importance to different DRBs/LCHs/PDCPs.

Detailed implementation processes are as follows (by taking the uplink as an example).

In S1, a UE receives RRC configuration parameters configured by a network.

In some embodiments, the RRC configuration parameters include the LCH configuration parameters.

In some embodiments, the LCH configuration parameters s include priority, prioritisedBitRate, bucketSizeDuration, and the LCH mapping restriction (for example, CG allowing LCH mapping, DG allowing LCH mapping).

In some embodiments, the RRC configuration parameters include more than one set of LCH configuration parameters. A set of LCH configuration parameters are parameters corresponding to the first LCP rule, the first MAC packetization mode, or the first LCH mapping restriction (another set of LCH configuration parameters includes parameters for normal transmission).

In some embodiments, the parameters corresponding to the first LCP rule, the first MAC packetization mode, or the first LCH mapping restriction are determined by the UE.

In some embodiments, the parameters corresponding to the first LCP rule, the first MAC packetization mode, or the first LCH mapping restriction are configured to ensure the priority transmission or processing of the media unit with the specific QoS requirement or importance or the data packet corresponding to the media unit.

In some embodiments, the RRC configuration parameters include corresponding information or indication information of the DRB/LCH/PDCP and the media units with different (or specific) QoS requirements or importance, or parameters or information of different QoS requirements or importance of the media units for the DRB/LCH/PDCP.

In some embodiments, the RRC configuration parameters include indication information indicating whether to enable the first LCP rule, whether to perform the first MAC packetization mode, or whether to use the first LCH mapping restriction. In some embodiments, the indication information is indicated to the UE in the DCI/MAC CE.

In S2, the UE acquires a data packet from a higher layer.

In some embodiments, a first layer of the UE determines, based on the indication of the higher layer or self-detection of the UE, whether the data packet is the media unit with the specific QoS requirement or importance or the data packet corresponding to the media unit.

In some embodiments, the first layer is one of the SDAP, the PDCP, and the MAC.

In some embodiments, the first layer of the UE informs the MAC layer of the UE of the determined information, or the first layer instructs the MAC layer of the UE to use the first LCP rule, or perform the first MAC packetization, or use the first LCH mapping restriction.

In some embodiments, the “specific” indicates the high QoS requirement or importance, the QoS requirement or importance greater than a threshold, or carries a specific identifier.

In S3, the UE performs the LCP/MAC PDU packetization and transmits the packet.

In some embodiments, an entity for performing S3 is a MAC entity of the UE.

In some embodiments, in the case that the first condition is met, the UE uses the first LCP rule, or performs the first MAC packetization, or performs the LCP/MAC PDU packetization by using the first LCH mapping restriction, and transmits the packet.

In some embodiments the first condition includes at least one of:
the indication information of the first layer of the UE is acquired;
the media unit with the specific QoS requirement or importance or the data packet corresponding to the media unit is present, or transmission of the media unit with the specific QoS requirement or importance or the data packet corresponding to the media unit is not completed;
the size of the available resource is less than the amount of the media unit with the specific QoS requirement or importance or the data packet corresponding to the media unit;
LCH parameters corresponding to the media unit with the specific QoS requirement or importance or the data packet corresponding to the media unit are not matched with the amount of the media unit with the specific QoS requirement or importance or the data packet corresponding to the media unit. For example, the token bucket size of the LCH is less than the amount of the media unit with the specific QoS requirement or importance or the data packet corresponding to the media unit;
a transmission delay of the media unit with the specific QoS requirement or importance or the data packet corresponding to the media unit is greater than the first delay threshold (and thus is ensured with priority); or
a transmission delay of the media unit with the non-specific QoS requirement or importance or the data packet corresponding to the media unit is greater than the first delay threshold (and thus is ensured with low priority, and it is no matter in the case of being lost).

In some embodiments, the first LCP rule, the first MAC packetization mode, or the first LCH mapping restriction is one of: modifying the LCH mapping restriction or using the A set of LCH mapping restriction.

In the case that a plurality of LCHs may be mapped to a resource, and one of the plurality of LCHs is an LCH corresponding to the media unit with the specific QoS requirement or importance or the data packet corresponding to the media unit. In this case, only the LCH corresponding to the media unit with the specific QoS requirement or importance or the data packet corresponding to the media unit is allowed to be mapped onto the resource.

In some embodiments, the LCP process or the PDU packetization process is modified, or the A set of LCH mapping restriction is used, such that the media unit with the non-specific QoS requirement or importance or the data packet corresponding to the media unit is included in the allocated grant.

For example, the UE temporarily modifies the token bucket size of the LCH/LCH group/LCH set corresponding to the ADU, such that the associated ADU is multiplexed with priority. For example, the prioritisedBitRate is set as infinity.

In some embodiments, the token bucket size is not modified, but the UE multiplex with priority the data of the associated ADU to the grant.

In some embodiments, in the case that the second condition is met, the UE performs normal transmission, or performs the LCP/MAC PDU packetization based on the RRC configuration parameters (non-A set), and transmits the packet.

In some embodiments, the second condition includes at least one of:
the indication information of the first layer of the UE is acquired, and indicates the media unit with the non-specific QoS requirement or importance or the data packet corresponding to the media unit;
the media unit with the specific QoS requirement or importance or the data packet corresponding to the media unit is not present, or the transmission of the media unit with the specific QoS requirement or importance or the data packet corresponding to the media unit is completed;
the size of the available resource is greater than or equal to the amount of the media unit with the specific QoS requirement or importance or the data packet corresponding to the media unit;
the LCH parameters corresponding to the media unit with the specific QoS requirement or importance or the data packet corresponding to the media unit are matched with the amount of the media unit with the specific QoS requirement or importance or the data packet corresponding to the media unit. For example, the token bucket size of the LCH is greater than or equal to the amount of the media unit with the specific QoS requirement or importance or the data packet corresponding to the media unit;
a duration of using the first LCP rule, performing the first MAC packetization mode, or using the first LCH mapping restriction reaches a first duration;
indication of the network indicating that the first LCP rule is not used, the first MAC packetization mode is not performed, or the first LCH mapping restriction is not used is received;
the transmission delay of the media unit with the specific QoS requirement or importance or the data packet corresponding to the media unit is less than a threshold; or
a to-be-transmitted amount of the media unit with the specific QoS requirement or importance or the data packet corresponding to the media unit is less than a threshold.

In some embodiments, in the case that the UE determines whether the packet is the packet corresponding to the media unit with the specific QoS requirement or importance or the data packet corresponding to the media unit, the UE reports the indication information to a base station, but does not use the first LCP rule, or perform the first MAC packetization mode, or use the first LCH mapping restriction. The first indication information is configured for the network to determine that the media unit with the specific QoS requirement or importance or the data packet corresponding to the media unit is present, or configured to assist the network to adjust the RRC configuration parameters, and configured to ensure transmission or the prioritized transmission of the media unit with the specific QoS requirement or importance or the data packet corresponding to the media unit.

The technical effects of the first embodiments are that the LCP rule is modified for a specific media unit to ensure the processing of the service with the priority or the high QoS requirement is prioritized.

In the second embodiments, the UE activates the first CG resource based on the QoS requirement or the importance of the media unit. The first CG resource is configured to transmit the media unit with the specific QoS requirement or importance or the data packet/LCH corresponding to the media unit.

In some embodiments, the second embodiments are applicable to a case of mapping media units/streams with different QoS requirements or importance to different DRBs/LCHs/PDCPs, and/or a case of mapping media units/streams with the same QoS requirement or importance to different DRBs/LCHs/PDCPs.

Detailed implementation processes are as follows (by taking the uplink as an example).

In S1, a UE receives RRC configuration parameters configured by a network.

In some embodiments, the RRC configuration parameters include the LCH configuration parameters.

In some embodiments, the LCH configuration parameters include priority, prioritisedBitRate, bucketSizeDuration, and the LCH mapping restriction (for example, CG allowing LCH mapping, DG allowing LCH mapping).

In some embodiments, the RRC configuration parameters include a first CG resource configuration for configuring the first CG resource.

In some embodiments, the first CG resource is only associated with the LCH corresponding to the media unit with the specific QoS requirement or importance or the data packet corresponding to the media unit. That is, the first CG resource is only associated with the LCH by the LCH mapping restriction.

In some embodiments, the first CG resource is a type-1 CG and/or a type-2 CG resource.

In some embodiments, the RRC configuration parameters include indication information indicating whether to enable the UE to self-activate/deactivate the first CG resource.

In some embodiments, the indication information is indicated to the UE in the DCI/MAC CE.

In S2, the UE acquires a data packet from a higher layer.

In some embodiments, a first layer of the UE determines, based on the indication of the higher layer or detection of the UE, whether the data packet is the media unit with the specific QoS requirement or importance or the data packet corresponding to the media unit.

In some embodiments, the first layer is one of the SDAP, the PDCP, or the MAC.

In some embodiments, the first layer of the UE informs the MAC layer of the UE of the determined information, or the first layer instructs the MAC layer of the UE to activate the first CG resource.

In some embodiments, the “specific” indicates the high QoS requirement or importance, or the QoS requirement or importance greater than a threshold, or carrying a specific identifier.

In S3, the UE transmits the data packet using an uplink resource.

In some embodiments, an entity for performing S3 is the MAC of the UE.

In some embodiments, an initial state of the first CG resource is a deactivated state.

In some embodiments, the UE activates the first CG resource in the case that the third condition is met.

In some embodiments, the third condition includes at least one of:
the indication information of the first layer of the UE is acquired;
the media unit with the specific QoS requirement or importance or the data packet corresponding to the media unit is present, or transmission of the media unit with the specific QoS requirement or importance or the data packet corresponding to the media unit is not completed;
the size of the available resource is less than the amount of the media unit with the specific QoS requirement or importance or the data packet corresponding to the media unit;
the LCH parameters corresponding to the media unit with the specific QoS requirement or importance or the data packet corresponding to the media unit are not matched with the amount of the media unit with the specific QoS requirement or importance or the data packet corresponding to the media unit. For example, the token bucket size of the LCH is less than the amount of the media unit with the specific QoS requirement or importance or the data packet corresponding to the media unit;
the transmission delay of the media unit with the specific QoS requirement or importance or the data packet corresponding to the media unit is greater than a threshold (and thus is ensured with priority); or
a to-be-transmitted amount of the media unit with the specific QoS requirement or importance or the data packet corresponding to the media unit is greater than a threshold.

In some embodiments, in the case that the first CG resource is activated, the UE transmits the media unit with the specific QoS requirement or importance or the data packet/LCH corresponding to the media unit using the first CG resource, such that an available transmission resource of a specific media unit is increased.

In some embodiments, the UE deactivates the first CG resource in the case that the fourth condition is met.

In some embodiments, the fourth condition includes at least one of:
the indication information is received from the first layer of the UE, and indicates the media unit with the non-specific QoS requirement or importance or the data packet corresponding to the media unit;
the media unit with the specific QoS requirement or importance or the data packet corresponding to the media unit is not present, or the transmission of the media unit with the specific QoS requirement or importance or the data packet corresponding to the media unit is completed;
the size of the available resource is greater than or equal to the amount of the media unit with the specific QoS requirement or importance or the data packet corresponding to the media unit;
the LCH parameters corresponding to the media unit with the specific QoS requirement or importance or the data packet corresponding to the media unit are matched with the amount of the media unit with the specific QoS requirement or importance or the data packet corresponding to the media unit. For example, the token bucket size of the LCH is greater than or equal to the amount of the media unit with the specific QoS requirement or importance or the data packet corresponding to the media unit;
a duration of deactivating the first CG resource reaches a duration;
the indication of the network indicating that the first CG resource is deactivated or not used is received;
the transmission delay of the media unit with the specific QoS requirement or importance or the data packet corresponding to the media unit is less than a threshold; or
the to-be-transmitted amount of the media unit with the specific QoS requirement or importance or the data packet corresponding to the media unit is less than a threshold.

In some embodiments, in the case that the first CG resource is deactivated, the UE uses resources other than the first CG resource to transmit the media unit with the specific QoS requirement or importance or the data packet/LCH corresponding to the media unit, such that more resources are used for transmission of other UE, and a whole capacity of the system is improved.

In some embodiments, in the case that the UE determines whether the packet is the packet corresponding to the media unit with the specific QoS requirement or importance or the data packet corresponding to the media unit, the UE reports the indication information to the base station, but does not directly activate the first CG resource, and activation and deactivation of the CG are controlled by the network. The first indication information is configured for the network to determine that the media unit with the specific QoS requirement or importance or the data packet corresponding to the media unit is present, configured to assist the network to activate the CG, and configured to ensure transmission or the priority transmission of the media unit with the specific QoS requirement or importance or the data packet corresponding to the media unit.

The technical effects of the first embodiments are that the UE self-activates or deactivates the CG resource for the specific media unit to ensure the priority processing of the service with the priority or the high QoS requirement.

In the third embodiments, the UE deletes, based on the QoS requirement or the importance of the media unit, the media unit with the non-specific QoS requirement or importance or the data packet corresponding to the media unit in the buffer, or the data packet with a delay greater than the first threshold in the buffer, or the media unit with the non-specific QoS requirement or importance or the data packet corresponding to the media unit with a delay greater than the first threshold in the buffer, or prioritizing submits the media unit with the specific QoS requirement or importance or the data packet corresponding to the media unit to the lower layer.

The third embodiments are applicable to a case of mapping media units/streams with different QoS requirements or importance to different DRBs/LCHs/PDCPs, and/or a case of mapping media units/streams with the same QoS requirement or importance to different DRBs/LCHs/PDCPs.

Detailed implementation processes are as follows (by taking the uplink as an example).

In S1, a UE receives RRC configuration parameters configured by a network.

In some embodiments, the RRC configuration parameters include the LCH configuration parameters.

In some embodiments, the RRC configuration parameters include the first CG resource configuration.

In some embodiments, the first CG resource is only associated with the LCH corresponding to the media unit with the specific QoS requirement or importance or the data packet corresponding to the media unit. That is, the first CG resource is only associated with the LCH by the LCH mapping restriction.

In some embodiments, the first CG resource is a type-1 CG and/or a type-2 CG resource.

In some embodiments, the configuration parameters include PDCP parameters, for example, a discard timer.

In some embodiments, the configuration parameters include corresponding information or indication information of the DRB/LCH/PDCP and the media units with different (or specific) QoS requirements or importance, or parameters or information of different QoS requirements or importance of the media units for the DRB/LCH/PDCP.

In S2, the UE acquires a data packet from a higher layer, and performs a third processing operation.

In some embodiments, a second layer of the UE determines, based on the indication of the higher layer or detection of the UE, whether the packet is the media unit with the specific QoS requirement or importance or the data packet corresponding to the media unit.

In some embodiments, the second layer is one of the SDAP, the PDCP, the RLC, or the MAC.

In some embodiments, the second layer of the UE informs the third layer of the UE of the determined information, or informs the UE to delete the packet, or the like.

In some embodiments, the third layer is one of the PDCP, the RLC, or the MAC.

In some embodiments, the “specific” indicates the high QoS requirement or importance, or the QoS requirement or importance greater than a threshold, or carrying a specific identifier.

In some embodiments, the third processing operation is performed by the third layer of the UE.

In some embodiments, the third processing operation includes at least one of:
deleting the media unit with the non-specific QoS requirement or importance or the data packet corresponding to the media unit in the buffer;
deleting the data packet with the delay exceeding the first threshold in the buffer;
deleting the media unit with the non-specific QoS requirement or importance or the data packet corresponding to the media unit with the delay exceeding the first threshold in the buffer; or
prioritizing submitting the media unit with the specific QoS requirement or importance or the data packet corresponding to the media unit to the lower layer.

In some embodiments, the third processing operation is performed in the case that the fifth condition is met. The fifth condition includes at least one of:
the indication information of the second layer of the UE is acquired;
the media unit with the specific QoS requirement or importance or the data packet corresponding to the media unit is present, or transmission of the media unit with the specific QoS requirement or importance or the data packet corresponding to the media unit is not completed;
the to-be-transmitted amount in the buffer of the UE is greater than or equal to the first threshold. The buffer is a storage buffer or a transmission buffer of the RLC/PDCP/MAC;
the transmission delay of the media unit with the specific QoS requirement or importance or the data packet corresponding to the media unit is greater than a threshold (and thus is ensured with priority);
the transmission delay of the media unit with the non-specific QoS requirement or importance or the data packet corresponding to the media unit is greater than the first delay threshold (and thus it is no matter in the case of being lost);
an PDB requirement of the media unit with the specific QoS requirement or importance or the data packet corresponding to the media unit is higher than a threshold (a tolerance delay is low); or
the to-be-transmitted amount of the media unit with the specific QoS requirement or importance or the data packet corresponding to the media unit is greater than a threshold (an occupied space is great, and unimportant data is deleted, such that important data is transmitted in the grant first).

In some embodiments, the MAC of the UE determines the media unit with the specific QoS requirement or importance or the data packet corresponding to the media unit as a high-prioritized data packet, determines a HARQ process corresponding to the media unit with the specific QoS requirement or importance or the data packet corresponding to the media unit as a prioritized HARQ process, or determines grant corresponding to the media unit with the specific QoS requirement or importance or the data packet corresponding to the media unit as a prioritized grant.

In some embodiments, the MAC layer of the UE determines the media unit with the non-specific QoS requirement or importance or the data packet corresponding to the media unit as a low-prioritized packet, or determines a HARQ process corresponding to the media unit with the non-specific QoS requirement or importance or the data packet corresponding to the media unit as a low-prioritized HARQ process, or determines grant corresponding to the media unit with the non-specific QoS requirement or importance or the data packet corresponding to the media unit as low-prioritized grant.

In some embodiments, the MAC layer of the UE determines, based on a mapping relationship between the DRB, the LCH, the HARQ process, or the grant and the data, whether the DRB, the LCH, the HARQ process, or the grant corresponds to the media unit with the specific QoS requirement or importance or the data packet corresponding to the media unit.

In some embodiments, the DRB or the LCH has a mapping relationship with the data (for example, the media unit or the data packet corresponding to the media unit), that is, the DRB or the LCH has a mapping relationship with the QoS requirement or importance of the data. That is, the DRB or the LCH corresponds to (or meets) the QoS requirement or importance, or the DRB or the LCH corresponds to (or, meets) the data of the QoS requirement or importance, or the DRB or the LCH has a specific identifier. In some embodiments, the specific identifier corresponds to the data with the specific QoS requirement or importance. That is, the case that the DRB or the LCH corresponds to the data with the specific QoS requirement or importance is determined based on the specific identifier.

In some embodiments, the MAC layer of the UE determines, based on a mapping relationship between the HARQ process or the grant and the DRB or the LCH, whether the HARQ process or the grant corresponds to the media unit, or the data packet corresponding to the media unit, or the DRB, or the LCH with the specific QoS requirement or importance.

In some embodiments, the MAC layer of the UE determines, based on a mapping relationship between the HARQ process and the DRB and a mapping relationship between the DRB and the media unit or the data packet corresponding to the media unit, whether the HARQ process corresponds to the DRB with the specific QoS requirement or importance.

In some embodiments, the MAC layer of the UE determines, based on a mapping relationship between the grant and the DRB and a mapping relationship between the DRB and the media unit or the data packet corresponding to the media unit, whether the grant corresponds to the DRB with the specific QoS requirement or importance.

In some embodiments, the MAC layer of the UE determines, based on a mapping relationship between the grant and the DRB and a mapping relationship between the DRB and the media unit or the data packet corresponding to the media unit, whether the grant corresponds to the media unit with the specific QoS requirement or importance or the data packet corresponding to the media unit.

The technical effects of the third embodiments are that the UE deletes the data packet corresponding to the non-specific media unit to ensure the priority processing of the service with the priority or the high QoS requirement.

In summary, the UE uses the first LCP rule, performs the first MAC packetization, or uses the first LCH mapping restriction based on the QoS requirement or the importance of the media unit; or the UE activates the first CG resource based on the QoS requirement or the importance of the media unit, wherein the first CG resource is configured to transmit the media unit with the specific QoS requirement or importance or the data packet or the LCH corresponding to the media unit; or the UE deletes, based on the QoS requirement or the importance of the media unit, the media unit with the non-specific QoS requirement or importance or the data packet corresponding to the media unit in the buffer, or the data packet with a delay greater than the first threshold in the buffer, or the media unit with the non-specific QoS requirement or importance or the data packet corresponding to the media unit with a delay greater than the first threshold in the buffer, or prioritizing submits the media unit with the specific QoS requirement or importance or the data packet corresponding to the media unit to the lower layer.

The embodiments of the method according to the present disclosure are described in detail in conjunction with FIGS. 2 to 6, and the embodiments of the apparatus according to the present disclosure is described in detail in conjunction with FIGS. 7 to 11. It should be understood that the descriptions of the embodiments of the apparatus correspond to the embodiments of the method, and for similar descriptions, reference may be made to the embodiments of the method.

FIG. 7 is a schematic block diagram of a terminal device 400 according to some embodiments of the present disclosure. As shown in FIG. 7, the terminal device 400 includes:
a processing unit 410, configured to perform a processing operation on data based on transmission requirement information of the data.

In some embodiments, the transmission requirement information of the data includes at least one of: a QoS requirement of the data, importance of the data, a QoS requirement of a path of the data, or importance of a path of the data.

In some embodiments, the data is a media unit or a data packet corresponding to a media unit.

In some embodiments, the terminal device 400 further includes:
a communication unit, configured to receive first configuration information from a network device, wherein the first configuration information includes LCH parameters corresponding to the data.

In some embodiments, the first configuration information includes second LCH parameters, or the first configuration information includes first LCH parameters and second LCH parameters; wherein the first LCH parameters are configured for data with a specific transmission requirement, and the second LCH parameters are configured for data with a non-specific transmission requirement.

In some embodiments, the first LCH parameters include parameters corresponding to a first processing operation, wherein the first processing operation includes at least one of:
performing LCP processing on the data using a first LCP rule;
packetizing the data using a first MAC packetization mode; or
performing LCH mapping and/or resource selection on the data using a first LCH mapping restriction.

In some embodiments, the second LCH parameters include parameters corresponding to a second processing operation, wherein the second processing operation includes at least one of:
performing LCP processing on the data using a second LCP rule;
packetizing the data using a second MAC packetization mode; or
performing LCH mapping and/or resource selection on the data using a second LCH mapping restriction.

In some embodiments, the first configuration information further includes:
a first correspondence, indicating a correspondence between at least one of a DRB, an LCH, or a PDCP layer and the transmission requirement information of the data; or
first parameter information, indicating transmission requirement parameters of data associated with at least one of a DRB, an LCH, or a PDCP layer.

In some embodiments, the first configuration information further includes: first indication information, indicating whether to activate the first LCH parameters, or whether to enable a first processing operation.

In some embodiments, the processing unit 410 is further configured to perform a first processing operation on the data in response to a first condition being met, wherein the first processing operation includes at least one of:
performing LCP processing on the data using a first LCP rule;
acquiring a MAC PDU by packetizing the data using a first MAC packetization mode; or
performing LCH mapping and/or resource selection on the data using a first LCH mapping restriction.

In some embodiments, the first condition includes at least one of:
the data is data with a specific transmission requirement;
a MAC layer of the terminal device receives second indication information from a first layer of the terminal device, wherein the second indication information indicates that the data is the data with the specific transmission requirement, or the second indication information is designed to instruct to perform the first processing operation;
a buffer of the terminal device includes the data with the specific transmission requirement;
transmission of the data with the specific transmission requirement is not completed;
a quantity of available resources is less than an amount of the data with the specific transmission requirement;
LCH parameters corresponding to the data with the specific transmission requirement are not matched with the amount of the data with the specific transmission requirement;
currently used LCH parameters are not matched with the amount of the data with the specific transmission requirement;
a transmission delay of the data with the specific transmission requirement is greater than a first delay threshold;
a transmission delay of data with a non-specific transmission requirement is greater than a second delay threshold;
a duration of disabling the first processing operation reaches a third duration; or a duration of enabling a second processing operation reaches a second duration.

In some embodiments, the data with the specific transmission requirement includes at least one of: data with a high QoS requirement, data with high importance, data with a QoS requirement higher than a first QoS threshold, data with importance higher than a first importance threshold, or data carrying a specific identifier.

In some embodiments, the first layer of the terminal device includes at least one of: a SDAP layer, a PDCP layer, or the MAC layer.

In some embodiments, the processing unit 410 is further configured to:
acquire the data from a higher layer of the terminal device in the first layer, wherein the higher layer of the terminal device is above the first layer;
determine whether the data is the data with the specific transmission requirement in the first layer; or
determine whether the data is the data with the specific transmission requirement based on indication of a higher layer of the terminal device in the first layer.

In some embodiments, the processing unit 410 is further configured to:
modify a second LCH mapping restriction, and perform the LCH mapping and/or the resource selection on the data using the modified second LCH mapping restriction, wherein the second LCH mapping restriction is configured for data with a non-specific transmission requirement; or
perform the LCH mapping and/or the resource selection on the data using the first LCH mapping restriction, wherein the first LCH mapping restriction is configured for data with a specific transmission requirement.

In some embodiments, the modified second LCH mapping restriction or the first LCH mapping restriction includes: in the case that a plurality of LCHs are to be mapped onto a first resource, and a first LCH in the plurality of LCHs is an LCH corresponding to data with a specific transmission requirement, only the LCH corresponding to the data with the specific transmission requirement is allowed to be mapped onto the first resource.

In some embodiments, the processing unit 410 is further configured to: modify a second LCP rule, and perform the LCP processing on the data using the modified second LCP rule, such that an uplink grant resource includes the data, wherein the second LCP rule is configured for data with a non-specific transmission requirement; or
perform the LCP processing on the data using the first LCP rule, such that an uplink grant resource includes the data, wherein the first LCP rule is configured for data with a specific transmission requirement.

In some embodiments, modifying the second LCP rule includes:
modifying a token bucket size and/or a prioritized bit rate (PBR) of an LCH corresponding to the data; or
in the case that a plurality of LCHs are to be mapped onto a first resource, and a first LCH in the plurality of LCHs is an LCH corresponding to data with a specific transmission requirement, prioritizing mapping the LCH corresponding to the data with the specific transmission requirement onto the first resource.

In some embodiments, the processing unit 410 is further configured to: modify a second MAC packetization mode, and packetize the data using the modified second MAC packetization mode, such that an uplink grant resource includes the data; or
packetize the data using the first MAC packetization mode, such that an uplink grant resource includes the data.

In some embodiments, the modified second MAC packetization mode or the first MAC packetization mode includes that the data with the specific transmission requirement is multiplexed with priority in the uplink grant resource.

In some embodiments, the processing unit 410 is further configured to: perform a second processing operation on the data in response to a second condition being met, wherein the second processing operation includes at least one of:
performing LCP processing on the data using a second LCP rule;
acquiring a MAC PDU by packetizing the data using a second MAC packetization mode; or
performing LCH mapping and/or resource selection on the data using a second LCH mapping restriction.

In some embodiments, the second condition includes at least one of:
the data is data with a non-specific transmission requirement;
a MAC layer of the terminal device receives third indication information from a first layer of the terminal device, wherein the third indication information indicates that the data is the data with the non-specific transmission requirement, or the third indication information is designed to instruct to perform the second processing operation;
a buffer of the terminal device contains no data with the specific transmission requirement;
transmission of the data with the specific transmission requirement is completed;
a quantity of available resources is greater than or equal to an amount of the data with the specific transmission requirement;
LCH parameters corresponding to the data with the specific transmission requirement are matched with the amount of the data with the specific transmission requirement;
currently used LCH parameters are matched with the amount of the data with the specific transmission requirement;
fourth indication information is received from the network device, wherein the fourth indication information is designed to disable a first processing operation;
a transmission delay of the data with the specific transmission requirement is less than or equal to a first delay threshold;
a transmission delay of the data with the non-specific transmission requirement is less than or equal to a second delay threshold;
a duration of enabling the first processing operation reaches a first duration; or
a duration of disabling the second processing operation reaches a fourth duration.

In some embodiments, the terminal device further includes:
a communication unit, configured to receive second configuration information from a network device, wherein the second configuration information includes LCH parameters corresponding to the data.

In some embodiments, the second configuration information includes first CG resource configuration, wherein the first CG resource configuration is designed to configure a first CG resource, wherein the first CG resource is associated with an LCH corresponding to data with a specific transmission requirement.

In some embodiments, the first CG resource includes at least one of a type-1 CG resource or a type-2 CG resource.

In some embodiments, the second configuration information further includes: fifth indication information, wherein the fifth indication information indicates whether to enable to self-activate the first CG resource, or whether to activate the first CG resource based on a condition.

In some embodiments, the processing unit 410 is further configured to: activate the first CG resource in response to a third condition being met.

In some embodiments, the third condition includes at least one of:
a MAC layer of the terminal device receives sixth indication information from a first layer of the terminal device, wherein the sixth indication information indicates that the data is the data with the specific transmission requirement, or the sixth indication information is designed to instruct to activate the first CG resource;
a buffer of the terminal device includes the data with the specific transmission requirement;
transmission of the data with the specific transmission requirement is not completed;
a quantity of available resources is less than an amount of the data with the specific transmission requirement;
LCH parameters corresponding to the data with the specific transmission requirement are not matched with the amount of the data with the specific transmission requirement;
currently used LCH parameters are not matched with the amount of the data with the specific transmission requirement;
a transmission delay of the data with the specific transmission requirement is greater than a third delay threshold;
a transmission delay of data with a non-specific transmission requirement is greater than a fourth delay threshold; or
a duration of deactivating the first CG resource based on a condition reaches a sixth duration.

In some embodiments, the processing unit 410 is further configured to:
acquire the data from a higher layer of the terminal device in the first layer, wherein the higher layer of the terminal device is above the first layer;
determine whether the data is the data with the specific transmission requirement in the first layer; or
determine whether the data is the data with the specific transmission requirement based on indication of a higher layer of the terminal device in the first layer.

In some embodiments, the terminal device further includes:
a communication unit, configured to transmit the data with the specific transmission requirement using the first CG resource in response to the first CG resource being activated.

In some embodiments, the processing unit 410 is further configured to: deactivate the first CG resource in response to a fourth condition being met.

In some embodiments, the fourth condition includes at least one of:
a MAC layer of the terminal device receives seventh indication information from a first layer of the terminal device, wherein the seventh indication information indicates that the data is data with a non-specific transmission requirement, or the seventh indication information is designed to instruct to deactivate the first CG resource;
a buffer of the terminal device contains no data with the specific transmission requirement;
transmission of the data with the specific transmission requirement is completed;
a quantity of available resources is greater than or equal to an amount of the data with the specific transmission requirement;
LCH parameters corresponding to the data with the specific transmission requirement are matched with the amount of the data with the specific transmission requirement;
currently used LCH parameters are matched with the amount of the data with the specific transmission requirement;
a duration of activating the first CG resource reaches a fifth duration;
eighth indication information is received from the network device, wherein the eighth indication information is designed to instruct to deactivate the first CG resource;
a transmission delay of the data with the specific transmission requirement is less than or equal to a first delay threshold;
a transmission delay of the data with the non-specific transmission requirement is less than or equal to a second delay threshold; or
a duration of activating the first CG resource based on a condition reaches the fifth duration.

In some embodiments, the processing unit 410 is further configured to: perform a third processing operation on the data based on the transmission requirement information of the data in a buffer of the terminal device.

In some embodiments, the third processing operation includes at least one of:
deleting data with a non-specific transmission requirement in the buffer;
deleting data with a transmission delay exceeding a fifth delay threshold in the buffer;
deleting the data with the non-specific transmission requirement of which the transmission delay exceeds a sixth delay threshold in the buffer;
prioritizing data with a specific transmission requirement, a hybrid automatic repeat request (HARQ) of data with a specific transmission requirement, or grant (for example, uplink grant or downlink grant) of data with a specific transmission requirement;
assigning a low priority to the data with the non-specific transmission requirement, a HARQ of the data with the non-specific transmission requirement, or grant corresponding to the data with the non-specific transmission requirement;
skipping the data with the non-specific transmission requirement, the HARQ of the data with the non-specific transmission requirement, or the grant corresponding to the data with the non-specific transmission requirement;
prioritizing submitting the data with the specific transmission requirement to a lower layer of the terminal device;
submitting the data with the non-specific transmission requirement to the lower layer of the terminal device with low priority;
prioritizing transmitting the data with the specific transmission requirement to an opposite end; or
transmitting the data with the non-specific transmission requirement to the opposite end with low priority.

In some embodiments, the third processing operation is performed in response to a fifth condition being met, wherein the fifth condition includes at least one of:
a third layer of the terminal device receives ninth indication information from a second layer of the terminal device, wherein the ninth indication information indicates that the data is data with a non-specific transmission requirement, or the ninth indication information is designed to instruct to perform the third processing operation;
a buffer of the terminal device includes data with a specific transmission requirement;
transmission of the data with the specific transmission requirement in the buffer of the terminal device is not completed;
an amount of the data in the buffer of the terminal device is greater than a third amount threshold;
a quantity of available resources is less than the amount of the data with the specific transmission requirement;
LCH parameters corresponding to the data with the specific transmission requirement are not matched with the amount of the data with the specific transmission requirement;
currently used LCH parameters are not matched with the amount of the data with the specific transmission requirement;
a transmission delay of the data with the specific transmission requirement is greater than a fifth delay threshold;
a transmission delay of the data with the non-specific transmission requirement is greater than a sixth delay threshold;
a packet delay budget (PDB) requirement of the data with the specific transmission requirement is higher than a first PDB threshold;
an amount of the data with the non-specific transmission requirement is greater than a fourth amount threshold;
a buffer delay of the data with the specific transmission requirement is greater than a seventh delay threshold; or
a buffer amount of the data with the specific transmission requirement is greater than a fifth amount threshold.

In some embodiments, the terminal device further includes:
a communication unit, configured to receive third configuration information from a network device, wherein the third configuration information includes parameters corresponding to the third processing operation.

In some embodiments, the third configuration information is designed to configure at least one of:
a second correspondence, indicating a correspondence between at least one of a DRB, an LCH, or a PDCP layer and the transmission requirement information of the data;
second parameter information, indicating transmission requirement parameters of data associated with at least one of the DRB, the LCH, or the PDCP layer; or
a discard timer corresponding to the data, wherein the data is deleted in response to expiration of the discard timer.

In some embodiments, data with a specific transmission requirement corresponds to a first discard timer, and data with a non-specific transmission requirement corresponds to a second discard timer, wherein a duration of the first discard timer is different from a duration of the second discard timer.

In some embodiments, the processing unit 410 is further configured to:
acquire the data from a higher layer of the terminal device in a second layer, wherein the higher layer of the terminal device is above the second layer;
determine whether the data is data with a specific transmission requirement in a second layer; or
determine whether the data is data with a specific transmission requirement based on indication of the higher layer of the terminal device in a second layer.

In some embodiments, the processing unit 410 is further configured to:
transmit ninth indication information to a third layer of the terminal device in the second layer, wherein the ninth indication information indicates that the data is data with a specific transmission requirement, or the ninth indication information is designed to instruct to perform the third processing operation.

In some embodiments, the second layer of the terminal device includes at least one of: a SDAP layer, a PDCP layer, an RLC layer, or a MAC layer.

In some embodiments, the third layer of the terminal device includes at least one of: a PDCP layer, an RLC layer, or a MAC layer.

In some embodiments, the above communication unit is a communicating interface or a transceiver, or a communication chip or an input and output interface of a system on chip. The above processing unit includes one or more processors.

It should be understood that the terminal device 400 in the embodiments of the present disclosure corresponds to the terminal device in the embodiments of the method, and above and other operations and/or functions of various units in the terminal device 400 are performed to achieve corresponding processes of the terminal device in the method 200 shown in FIGS. 2 to 5, which are not described herein for brevity.

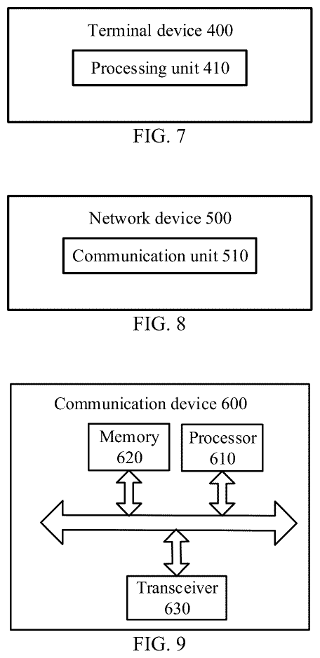

FIG. 8 is a schematic block diagram of a network device according to some embodiments of the present disclosure. The network device in FIG. 8 includes:
a communication unit 510, configured to transmit target configuration information to a terminal device, wherein the target configuration information is designed to configure LCH parameters for the terminal device to perform data processing and/or transmission.

In some embodiments, the target configuration information includes first configuration information, wherein the first configuration information includes first LCH parameters and second LCH parameters; wherein the first LCH parameters are configured for data with a specific transmission requirement, and the second LCH parameters are configured for data with a non-specific transmission requirement.

In some embodiments, the first LCH parameters include parameters corresponding to a first processing operation, wherein the first processing operation includes at least one of:
performing LCP processing on data using a first LCP rule;
packetizing the data using a first MAC packetization mode; or
performing LCH mapping and/or resource selection on the data using a first LCH mapping restriction.

In some embodiments, the second LCH parameters include parameters corresponding to a second processing operation, wherein the second processing operation includes at least one of:
performing LCP processing on data using a second LCP rule;
packetizing the data using a second MAC packetization mode; or
performing LCH mapping and/or resource selection on the data using a second LCH mapping restriction.

In some embodiments, the first configuration information further includes:
a first correspondence, indicating a correspondence between at least one of a DRB, an LCH, or a PDCP layer and transmission requirement information of data; or
first parameter information, indicating transmission requirement parameters of data associated with at least one of a DRB, an LCH, or a PDCP layer.

In some embodiments, the first configuration information further includes: first indication information, indicating whether to activate the first LCH parameters, or whether to enable a first processing operation.

In some embodiments, the target configuration information includes second configuration information, wherein the second configuration information includes first CG resource configuration, wherein the first CG resource configuration is designed to configure a first CG resource, wherein the first CG resource is associated with an LCH corresponding to data with a specific transmission requirement.

In some embodiments, the first CG resource includes at least one of a type-1 CG resource, or a type-2 CG resource.

In some embodiments, the second configuration information further includes: fifth indication information, wherein the fifth indication information indicates whether to enable to self-activate the first CG resource, or whether to activate the first CG resource based on a condition.

In some embodiments, the target configuration information includes third configuration information, wherein the third configuration information includes parameters corresponding to a third processing operation.

In some embodiments, the third processing operation includes at least one of:
deleting data with a non-specific transmission requirement in a buffer;
deleting data with a transmission delay exceeding a fifth delay threshold in the buffer;
deleting the data with the non-specific transmission requirement of which the transmission delay exceeds a sixth delay threshold in the buffer;
prioritizing data with a specific transmission requirement, a hybrid automatic repeat request (HARQ) of data with a specific transmission requirement, or grant (for example, uplink grant or downlink grant) of data with a specific transmission requirement;
assigning a low priority to the data with the non-specific transmission requirement, a HARQ of the data with the non-specific transmission requirement, or grant corresponding to the data with the non-specific transmission requirement;
skipping the data with the non-specific transmission requirement, the HARQ of the data with the non-specific transmission requirement, or the grant corresponding to the data with the non-specific transmission requirement;
prioritizing submitting the data with the specific transmission requirement to a lower layer of the terminal device;
submitting the data with the non-specific transmission requirement to the lower layer of the terminal device with low priority;
prioritizing transmitting the data with the specific transmission requirement to an opposite end; or
transmitting the data with the non-specific transmission requirement to the opposite end with low priority.

In some embodiments, the third configuration information is designed to configure at least one of:
a second correspondence, indicating a correspondence between at least one of a DRB, an LCH, or a PDCP layer and transmission requirement information of data;
second parameter information, indicating transmission requirement parameters of data associated with at least one of the DRB, the LCH, or the PDCP layer; or
a discard timer corresponding to the data, wherein the data is deleted in response to expiration of the discard timer.

In some embodiments, data with a specific transmission requirement corresponds to a first discard timer, and data with a non-specific transmission requirement corresponds to a second discard timer, wherein a duration of the first discard timer is different from a duration of the second discard timer.

In some embodiments, the data with the specific transmission requirement includes at least one of: data with a high QoS requirement, data with high importance, data with a QoS requirement higher than a first QoS threshold, data with importance higher than a first importance threshold, or data carrying a specific identifier.

In some embodiments, the above communication unit is a communicating interface or a transceiver, or a communication chip or an input and output interface of a system on chip. The above processing unit includes one or more processors.

It should be understood that the network device 500 in the embodiments of the present disclosure corresponds to the network device in the embodiments of the method, and above and other operations and/or functions of various units in the network device 500 are performed to achieve corresponding processes of the network device in the method 300 shown in FIG. 6, which are not described herein for brevity.

FIG. 9 is a schematic block diagram of a communication device 600 according to some embodiments of the present disclosure. The communication device 600 shown in FIG. 9 includes a processor 610. The processor 610, when loading and running one or more computer programs in a memory, is caused to perform the method according to the embodiments of the present disclosure.

In some embodiments, as shown in FIG. 9, the communication device 600 further includes a memory 620. The processor 610, when loading and running one or more computer programs in the memory 620, is caused to perform the method according to the embodiments of the present disclosure.

The memory 620 is a device separate from the processor 610, or is integrated in the processor 610.

In some embodiments, as shown in FIG. 9, the communication device 600 further includes a transceiver 630. The processor 610 controls communication of the transceiver 630 with other devices. In particular, the transceiver 630 transmits information or data to other devices, or receives information or data from other devices.

The transceiver 630 includes a transiter and a receiver. The transceiver 630 further includes one or more antennas.

In some embodiments, the communication device 600 is the network device in the embodiments of the present disclosure, and performs the corresponding processes performed by the network device in the method according to the embodiments of the present disclosure, which are not described herein for brevity.

In some embodiments, the communication device 600 is the mobile terminal/terminal device in the embodiments of the present disclosure, and performs the corresponding processes performed by the mobile terminal/terminal device in the method according to the embodiments of the present disclosure, which are not described herein for brevity.

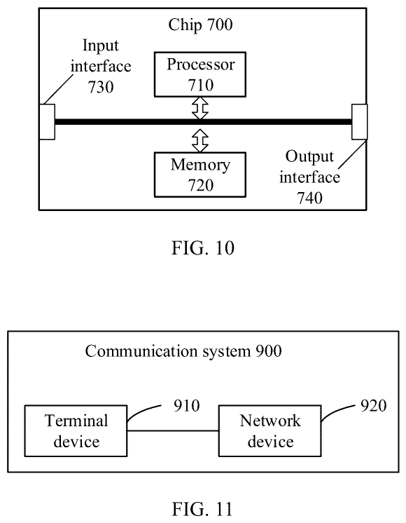

FIG. 10 is a schematic block diagram of a chip according to some embodiments of the present disclosure. The chip 700 shown in FIG. 10 includes a processor 710. The processor 710, when loading and running one or more computer programs in a memory, is caused to perform the method according to the embodiments of the present disclosure.

In some embodiments, as shown in FIG. 10, the chip 700 further includes a memory 720. The processor 710, when loading and running one or more computer programs in the memory 720, is caused to perform the method according to the embodiments of the present disclosure.

The memory 720 is a device separate from the processor 710, or is integrated in the processor 710.

In some embodiments, the chip 700 further includes an input interface 730. The processor 710 controls communication of the input interface 730 with other devices or chips. In particular, the input interface 730 acquires information or data from other devices or chips.

In some embodiments, the chip 700 further includes an output interface 740. The processor 710 controls communication of the output interface 740 with other devices or chips. In particular, the output interface 740 outputs information or data to other devices or chips.

In some embodiments, the chip 700 is applicable to the network device in the embodiments of the present disclosure, and performs the corresponding processes performed by the network device in the method according to the embodiments of the present disclosure, which are not described herein for brevity.

In some embodiments, the chip 700 is applicable to the mobile terminal/terminal device in the embodiments of the present disclosure, and performs the corresponding processes performed by the mobile terminal/terminal device in the method according to the embodiments of the present disclosure, which are not described herein for brevity.

It should be understood that the chip in the embodiments of the present disclosure is also referred to as a system-level chip, a system chip, a chip system, a system-on-chip, or the like.

FIG. 11 is a schematic block diagram of a communication system 900 according to some embodiments of the present disclosure. As shown in FIG. 11, the communication system 900 includes a terminal device 910 and a network device 920.

The terminal device 910 is configured to implement the corresponding functions implemented by the terminal device in the above method, and the network device 920 is configured to implement the corresponding functions implemented by the network device in the above method, which are not repeated for brevity.

It should be understood that the processor in the embodiments of the present disclosure is an integrated circuit chip with a signal processing capability. In the implementations, the processes in the embodiments of the method are achieved by integrated logic circuits of hardware in the processor or instructions in the software form. The above processor is a general processor, a digital signal processor (DSP), an application specific integrated circuit (ASIC), a field programmable gate array (FPGA), other programmable logic devices, discrete gates, transistor logic devices, or discrete hardware assemblies that can achieve or perform various methods, processes, and logic blocks according to the embodiments of the present disclosure. The general processor is a microprocessor, any conventional processor, or the like. The processes in conjunction with the method in the embodiments of the present disclosure are directly embodied as a hardware decoding processor for processing or are performed by a combination of hardware and software modules in the decoding processor. The software modules are disposed in a random access memory, a flash memory, a read-only memory (ROM), a programmable ROM (PROM), an electrically erasable PROM (EPROM), a register, and other storage mediums mature in the field. The storage medium is disposed in the memory, and the processor reads the information in the memory and combines with its hardware to perform the processes of the above method.

It should be understood that the memory in embodiments of the present disclosure is a volatile or non-volatile memory, or includes both the volatile memory and the non-volatile memory. The non-volatile memory is a ROM, a PROM, an EPROM, an electrically EPROM (EEPROM), or a flash memory. The volatile memory is a random access memory (RAM) used as an external buffer. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM). It should be noted that the system and the memory described herein are intended to include, but not limit to these and any other suitable type of memory.

It should be understood that the above memory are exemplary but not for limitation. For example, the memory in the embodiments of the present disclosure is also an SRAM, a DRAM, an SDRAM, a DDR SDRAM, an ESDRAM, an SLDRAM, a DR RAM, or the like. That is, the memory in the embodiments of the present disclosure is intend to include, but not limit to these and any other suitable type of memory.

Embodiments of the present disclosure further provide a non-transitory computer-readable storage medium for storing one or more computer programs.

In some embodiments, the non-transitory computer-readable storage medium is applicable to the network device in the embodiments of the present disclosure, and the one or more computer programs cause the computer to perform the corresponding processes performed by the network device in the method according to the embodiments of the present disclosure, which are not described herein for brevity.

In some embodiments, the non-transitory computer-readable storage medium is applicable to the mobile terminal/terminal device in the embodiments of the present disclosure, and the one or more computer programs cause the computer to perform the corresponding processes performed by of the mobile terminal/terminal device in the method according to the embodiments of the present disclosure, which are not described herein for brevity.

Embodiments of the present disclosure further provide a computer program product including one or more computer program instructions.

In some embodiments, the computer program product is applicable to the network device in the embodiments of the present disclosure, and the one or more computer program instructions, when loaded and executed by a computer, cause the computer to achieve the corresponding processes performed by the network device in the method according to the embodiments of the present disclosure, which are not described herein for brevity.

In some embodiments, the computer program product is applicable to the mobile terminal/terminal device in the embodiments of the present disclosure, and the one or more computer program instructions, when loaded and executed by a computer, cause the computer to perform the corresponding processes performed by the mobile terminal/terminal device in the method according to the embodiments of the present disclosure, which are not described herein for brevity.

Embodiments of the present disclosure further provide a computer program.

In some embodiments, the computer program is applicable to the network device in the embodiments of the present disclosure, and the computer program, when loaded and run on a computer, causes the computer to perform the corresponding processes performed by the network device in the method according to the embodiments of the present disclosure, which are not described herein for brevity.

In some embodiments, the computer program is applicable to the mobile terminal/terminal device in the embodiments of the present disclosure, and the computer program, when loaded and run on a computer, causes the computer to perform the corresponding processes performed by the mobile terminal/terminal device in the method according to the embodiments of the present disclosure, which are not described herein for brevity.

It can be understood by those of ordinary skill in the art that the units and algorithmic processes of the examples described in conjunction with the embodiments disclosed herein can be achieved by the electronic hardware, or by a combination of the computer software and the electronic hardware. Whether these functions are implemented by the hardware or the software depends on the specific application and design constraints of the technical solution. For each application, those skilled in the art may use different methods to achieve the described functions, and such implementations should not be considered beyond the scope of the present disclosure.

It can be understood by those skilled in the art that for the specific operation processes of the system, device, and unit described above, reference may be made to the corresponding processes in the above embodiments of the method for convenience and simplicity of description, which are not described herein.

In the embodiments of the present disclosure, it should be understood that the systems, devices, and methods can be implemented in other ways. For example, the above embodiments of the device are only exemplary. For example, the division of the units is only the logical function division, and the actual implementation may have another division. For example, several units or assemblies can be combined or integrated into another system, or some features can be ignored or not performed. In addition, the coupling, the direct coupling, or the communication connection between each other may be achieved by some interfaces, and an indirect coupling or communication connection between devices or units may be electrical, mechanical or in other form.

The units described as separate parts may or may not be physically separate, and the parts shown as the units may or may not be physical units. That is, the parts may be disposed in one place, or distributed in several network units. Some or all of the units can be selected according to actual needs to achieve the purpose of the technical solutions according to the embodiments.

In addition, the functional units in the embodiments of the present disclosure may be integrated in a processing unit or exist physically separately, or two or more units may be integrated in a unit.

In the case that the functions are achieved in the form of software functional units and sold or used as stand-alone products, the functions may be stored in a computer readable storage medium. Based on the understanding, the nature of the technical solutions of the present disclosure, the part contributed to the prior art, or the part of the technical solutions may be embodied in the form of a software product, and the software product is stored in a storage medium and includes a number of instructions for causing a computer device (which may be a personal computer, a server, a network equipment, or the like) to perform all or part of the processes of the method in various embodiments of the present disclosure. The above storage medium include: a U disk, a mobile hard disk, a ROM, a RAM, a disk, a disc, or other medium that can store program codes.

Described above are merely specific embodiments of the present disclosure, and the scope of protection of the present disclosure is not limited. Any changes or replacements made within the technical scope of the present disclosure by those skilled in the art should be encompassed within the scope of protection of the present disclosure. thus, the scope of protection of the present disclosure shall prevail in the scope of protection of the claims.

1. A method for wireless communication, comprising:
performing, by a terminal device, a processing operation on data based on transmission requirement information of the data.

2. The method according to claim 1, wherein the transmission requirement information of the data comprises at least one of: a quality of service (QOS) requirement of the data, importance of the data, a QoS requirement of a path of the data, or importance of a path of the data.

3. The method according to claim 1, further comprising:
receiving, by the terminal device, first configuration information from a network device, wherein the first configuration information comprises logical channel (LCH) parameters corresponding to the data.

4. The method according to claim 3, wherein the first configuration information comprises second LCH parameters, or the first configuration information comprises first LCH parameters and second LCH parameters; wherein the first LCH parameters are configured for data with a specific transmission requirement, and the second LCH parameters are configured for data with a non-specific transmission requirement.

5. The method according to claim 4, wherein the first LCH parameters comprise parameters corresponding to a first processing operation, wherein the first processing operation comprises at least one of:
performing logical channel prioritization (LCP) processing on the data using a first LCP rule;
packetizing the data using a first medium access control (MAC) packetization mode; and
performing LCH mapping and/or resource selection on the data using a first LCH mapping restriction.

6. The method according to claim 4, wherein the second LCH parameters comprise parameters corresponding to a second processing operation, wherein the second processing operation comprises at least one of:
performing logical channel prioritization (LCP) processing on the data using a second LCP rule;
packetizing the data using a second medium access control (MAC) packetization mode; and
performing LCH mapping and/or resource selection on the data using a second LCH mapping restriction.

7. The method according to claim 1, wherein performing, by the terminal device, the processing operation on the data based on the transmission requirement information of the data comprises:
performing a first processing operation on the data in response to a first condition being met, wherein the first processing operation comprises at least one of:
performing logical channel prioritization (LCP) processing on the data using a first LCP rule;
acquiring a medium access control protocol data unit (MAC PDU) by packetizing the data using a first MAC packetization mode; and
performing logical channel (LCH) mapping and/or resource selection on the data using a first LCH mapping restriction.

8. The method according to claim 7, wherein the first condition comprises at least one of the following items:
the data is data with a specific transmission requirement;
a MAC layer of the terminal device receives second indication information from a first layer of the terminal device, wherein the second indication information indicates that the data is data with a specific transmission requirement, or the second indication information is designed to instruct to perform the first processing operation;
a buffer of the terminal device contains data with a specific transmission requirement;
transmission of data with a specific transmission requirement is not completed;
a quantity of available resources is less than an amount of data with a specific transmission requirement;
LCH parameters corresponding to data with a specific transmission requirement are not matched with an amount of the data with the specific transmission requirement;
currently used LCH parameters are not matched with an amount of data with a specific transmission requirement;
a transmission delay of data with a specific transmission requirement is greater than a first delay threshold;
a transmission delay of data with a non-specific transmission requirement is greater than a second delay threshold;
a duration of disabling the first processing operation reaches a third duration; and
a duration of enabling a second processing operation reaches a second duration.

9. The method according to claim 1, wherein performing, by the terminal device, the processing operation on the data based on the transmission requirement information of the data comprises:
performing a second processing operation on the data in response to a second condition being met, wherein the second processing operation comprises at least one of:
performing logical channel prioritization (LCP) processing on the data using a second LCP rule;
acquiring a medium access control protocol data unit (MAC PDU) by packetizing the data using a second MAC packetization mode; and
performing logical channel (LCH) mapping and/or resource selection on the data using a second LCH mapping restriction.

10. A terminal device, comprising:
a processor and a memory storing one or more computer programs, which when executed by the processor, cause the terminal device to:
perform a processing operation on data based on transmission requirement information of the data.

11. The terminal device according to claim 10, wherein the one or more computer programs, which when executed by the processor, further cause the terminal device to:
perform a first processing operation on the data in response to a first condition being met, wherein the first processing operation comprises at least one of:
performing logical channel prioritization (LCP) processing on the data using a first LCP rule;
acquiring a medium access control protocol data unit (MAC PDU) by packetizing the data using a first MAC packetization mode; and
performing logical channel (LCH) mapping and/or resource selection on the data using a first LCH mapping restriction.

12. The terminal device according to claim 11, wherein the one or more computer programs, which when executed by the processor, further cause the terminal device to:
modify a second LCH mapping restriction, and perform the LCH mapping and/or the resource selection on the data using the modified second LCH mapping restriction, wherein the second LCH mapping restriction is configured for data with a non-specific transmission requirement; and
perform the LCH mapping and/or the resource selection on the data using the first LCH mapping restriction, wherein the first LCH mapping restriction is configured for data with a specific transmission requirement.

13. The terminal device according to claim 12, wherein the modified second LCH mapping restriction or the first LCH mapping restriction comprises:
in a case that a plurality of LCHs are to be mapped onto a first resource, and a first LCH in the plurality of LCHs is an LCH corresponding to data with a specific transmission requirement, only the LCH corresponding to the data with the specific transmission requirement is allowed to be mapped onto the first resource.

14. The terminal device according to claim 11, wherein the one or more computer programs, which when executed by the processor, further cause the terminal device to:
modify a second LCP rule, and perform the LCP processing on the data using the modified second LCP rule, such that an uplink grant resource comprises the data, wherein the second LCP rule is configured for data with a non-specific transmission requirement; or
perform the LCP processing on the data using the first LCP rule, such that an uplink grant resource comprises the data, wherein the first LCP rule is configured for data with a specific transmission requirement.

15. The terminal device according to claim 10, wherein the one or more computer programs, which when executed by the processor, further cause the terminal device to:
receive second configuration information from a network device, wherein the second configuration information comprises logical channel (LCH) parameters corresponding to the data;
wherein the second configuration information comprises a first configuration grant (CG) resource configuration, wherein the first CG resource configuration is designed to configure a first CG resource associated with an LCH corresponding to data with a specific transmission requirement.

16. A network device, comprising:
a processor and a memory storing one or more computer programs, which when executed by the processor, cause the network device to:
transmit target configuration information to a terminal device, wherein the target configuration information is designed to configure logical channel (LCH) parameters for the terminal device to perform data processing and/or transmission.

17. The network device according to claim 16, wherein the target configuration information comprises first configuration information, wherein the first configuration information comprises first LCH parameters and second LCH parameters; wherein the first LCH parameters are configured for data with a specific transmission requirement, and the second LCH parameters are configured for data with a non-specific transmission requirement.

18. The network device according to claim 17, wherein the first LCH parameters comprise parameters corresponding to a first processing operation, wherein the first processing operation comprises at least one of:
performing logical channel prioritization (LCP) processing on data using a first LCP rule;
packetizing the data using a first medium access control (MAC) packetization mode; and
performing LCH mapping and/or resource selection on the data using a first LCH mapping restriction.

19. The network device according to claim 17, wherein the second LCH parameters comprise parameters corresponding to a second processing operation, wherein the second processing operation comprises at least one of:
performing logical channel prioritization (LCP) processing on data using a second LCP rule;
packetizing the data using a second medium access control (MAC) packetization mode; and
performing LCH mapping and/or resource selection on the data using a second LCH mapping restriction.

20. The network device according to claim 16, wherein the target configuration information comprises second configuration information, wherein the second configuration information comprises a first configuration grant (CG) resource configuration, wherein the first CG resource configuration is designed to configure a first CG resource associated with an LCH corresponding to data with a specific transmission requirement.
